(19) United States
(12) Patent Application Publication
(10) Pub. No.: US 2017/0115189 A1
(43) Pub. Date: Apr. 27, 2017

(54) MICROTOME AND METHOD FOR OPERATING A MICROTOME

(71) Applicant: Hans Ludwig HEID, Bammental (DE)

(72) Inventor: Hans Ludwig HEID, Bammental (DE)

(21) Appl. No.: 15/301,658

(22) PCT Filed: Mar. 28, 2015
(86) PCT No.: PCT/DE2015/000161

§ 371 Date: Oct. 3, 2016

(30) Foreign Application Priority Data
Apr. 11, 2014 (DE) 10 2014 005 445.4

(51) Int. Cl. G01N 1/06

(52) U.S. Cl. CPC G01N 1/06; G01N 2001/066

(57) ABSTRACT

In a microtome (1) for producing thin sections for histology, there is a danger of collisions between the sample (9) and the cutting edge (7) in setup mode for coarse feed. It is an object of the invention to limit the collision force of such a collision so that it lies within an admissible range and, therefore, damage is avoided, and the microtome (1) is thereby inherently safe in setup mode. It is also an object of the invention, using the same means, to make available methods that resolve collisions and permit automatic approximation between sample (9) and cutting edge (7). The support force of the associated advancing means (18) acting in the advancing device (12) is limited since the otherwise customary screwing of the associated advancing means (18) on the advancing device (12) is replaced, for example, by a spring mounting or by a connection acting with magnetic force. Thus, when the support force is exceeded in the event of a collision, the associated advancing means (18) lift away from their contact face and experience a displacement (30). The collision force is thus limited to the support force. An additional switching off of the electromotive advancing drive and an associated process for resolving a collision via the electrical control (11) forms the basis of a further method for automatic approximation between sample (9) and cutting edge (7), which is likewise inherently safe by using the same means. The microtome (1) according

### CROSS-REFERENCE TO RELATED APPLICATION

This application claims the priority of the PCT application PCT/DE2015/000161 based on German application DE 10 2014 005 445 having a priority date of Apr. 11, 2014, the entire content of which is herewith incorporated by reference.

### BACKGROUND OF THE INVENTION

Technical Field

The invention describes a microtome with an electromotive feed system which has means incorporated for enhanced user safety and prevention of damage by limiting the applied forces at uncontrolled collisons between specimen and knife edge and thus making the microtome inherently save. Further the invention exhibits means which cause in addition a deactivation of the electromotive drive in a case of a collision and is providing with the same means a method for a thereof derived automated approach between specimen and knife edge.

Microtomes are sectioning instruments with primary use in histology, biology, medical research but also in materials science and quality assurance for producing thin sections of specimen. These sections are then used in microscopic, mainly light microscopic examination methods

Background Art

With all types of microtomes the production of thin sections in the sectioning process is performed by a relative movement of a clamped specimen and the cutting edge of a sectioning tool along a linear or curved sectioning path. Thereby the section thickness of the resulting section is basically the amount of feed which is carried out in a previous step as a relative movement to each other between specimen and sectioning tool. This feed movement is typically, but not necessarily, in a vertical direction to the sectioning movement. The feed can either be carried out as feed of the specimen by the specimen holder or as feed of the sectioning tool by the knife carrier.

Common microtomes differ in their type of construction as there are rocking microtomes with knife carrier feed system, sledge microtomes with knife carrier or specimen feed systems, disk microtomes with knife carrier feed system and rotary microtomes with knife carrier or specimen feed systems. Microtomes used in microtome-cryostats to produce frozen sections are called cryostat-microtomes. Fundamentally they also differ as to the named types of construction and types of feed system. It should be noted, that in general each type of microtome can be represented either with knife carrier feed system or with specimen feed system.

State of the art microtomes of all named types have at their feed system a guidance body which is either firmly connected to a main body of the respective microtome or to a support body which moves directed along the sectioning path of the microtome. Thereby it is depending on the type of microtome and depending whether there is a knife carrier feed system or a specimen feed system to determine to which of the named parts the feed system is connected. The connection of the guidance body with either the main body or the support body can be arranged by fastening with screws, by glueing together or by other fastening techniques but also by being one piece together with the main body or the support body respectively.

The feed system thereby always consists of the guidance body, a thereon or therein moveable guiding element and interconnected feed means. The interconnected feed means for example may consist of a spindle with nut, a spindle bearing with bearing elements, a bearing housing and a driving element for the feed movement. Other forms of interconnected feed means for example can contain rack and pinion drives, worm gear arrangements or rope pull system components. Common to all arrangements of interconnected feed means in the state of the art is, that at least one functional part of these interconnected feed means is fixedly connected with the guidance body, for example by screw connection or is in one piece with it and that at least one further functional part of these interconnected feed means drives the moveable guiding element when the driving element is initiated.

When starting sectioning a specimen and producing successive thin sections of it, there is to overcome initially the difficulty to minimize the unknown distance between a specimen of variable size and the knife edge. That procedure in the set-up phase of sectioning is called approach and is typically performed 80-120 times during a work day in a routine lab. Thereby ideally the middle of the specimen is positioned at about same height as the knife edge of the sectioning tool opposite to it in a certain distance. Then a so called coarse feed movement is carried out with the feed system of the microtome to minimize the distance between specimen and knife edge in order to enable the following first cuts, the so called trim-sections of the specimen, in a secure and appropriate manner.

It should be mentioned, that with most microtomes, whether they have knife carrier feed system or specimen feed system, it is possible for example, to loosen the knife carrier from its base by unlocking clamping levers and manually shift it towards the specimen until touching and then lock the clamping levers again. The same procedure is also feasible with specimen clamps, if they would be equipped with clamping mechanisms to unlock. This type of an approach between specimen and knife edge is outermost non-ergonomic and will be not followed up further.

It is state of the art with mechanically acting feed mechanisms to have safety mechanisms to avoid demolitions on microtome parts during feed movements. WO 95/14 219 A1 is describing a purely mechanical working microtome where the manually operated coarse feed system is secured with a slip clutch when reaching the limit stop and where the mechanically working micrometer mechanism has a safeguard against inner disruption when reaching the limit stop.

WO 2004/ 029 587 A1 is also describing a mechanically feeding microtome with a manual coarse feed, where the coarse feed handwheel is equipped with a slip clutch to avoid demolitions in case of a blockage between coarse feed mechanism and feeding spindle.

The state of the art is also including solutions for spindle based feed systems, which offer the desired zero backlash of the feed systems by using spring assemblies. DE 34 04 098 C2 is describing a microtome with mechanical feed system with a spindle and with a mechanically acting retraction mechanism, which interferes with a spring loaded spindle bearing.

In DE 37 27 975 C2 is the description of a microtome with mechanical feed system based on a spindle, which incorporates spring assemblies between the spindle and divided nuts and at the spindle and nut bearings respectively in order to avoid backlash.

DE 34 04 097 C1 describes a microtome with an electromotive coarse feed system in superimposition of a purely mechanical fine feed system. DE 29612938U1 describes a microtome which applies preferably a stepping motor to operate coarse and fine feed. It is generally state of the art with all construction types of microtomes to use stepping motors for feed systems.

With such microtomes the above said coarse feed movement, for minimizing the distance between the specimen and the knife edge before starting with trim sections, is carried out by a corresponding operational command with a switch or with a keypad by simultaneously careful observation of the shrinking distance between specimen and knife edge. Thereby the difficulty is on the one hand to approach under visual control as close as possible between specimen and knife edge, but on the other hand to avoid a collision between specimen and knife edge as this may lead to damages of the knife edge but also the specimen as well. The necessity to approach as close as possible comes from the fact that the required section thickness of trim-sections is typically below 30 μm. Thus right away first sections will only be produced after such an approach, if the remaining distance between specimen and knife edge is already in that range. For a better visual control of the gap between specimen surface and knife edge it is also common to use optical accessories like stereomicroscopes or magnifying glasses, which may also be equipped with additional illumination devices.

This is cumbersome and non-ergonomic and does not guarantee securely to prevent a collision, because the blank specimen surface also has unevenness. Moreover there is always the risk of operating error with respective damages at the specimen and/or the knife edge. With gross operating errors or with a first failure of a technical means there is also to a certain degree the danger of injury, for example bruises at the fingers of the operator.

In order to avoid the erroneous and time consuming specimen approach under manual control of the coarse feed automatic approach systems were implemented. A microtome is known from DE 42 05 256 C2, that has an electromotive feed system for coarse and fine feed and an automatic approach system. With that device, which is mounted on the rear side of the knife carrier and where the specimen is positioned at the end of the sectioning path, the danger and the difficulty which is associated with a manually operated approach under visual control can be avoided. However in practical use, there was found a significant impairment of the functionality by soiling of sectioning debris, because the device is positioned in the area of generating sections. This leads to malfunctions and respective efforts to reinstall the correct function.

DE10258553B4 is describing a device for automatic approach by using a light barrier. The location for this device is again in the area between knife carrier and specimen holder and therefore exposed to functional limitations due to soiling.

DE19911173C2 describes an automatic approach system based on a pressure sensor which is positioned in determined reference to the knife edge. The location of the sensor is again in the area of potential soiling between knife carrier and specimen holder with the respective disadvantages for precision and functional efficiency of the device.

In DE102007023457B4 a method is proposed for an automatic approach based on a light barrier with a light band and generating a reference value in respect to the knife edge. But again the location of the optical means is in the gap between knife carrier and specimen holder and therefore afflicted with the same disadvantages mentioned above.

EP 2 503 315 A2 finally describes a microtome with an electromotive feed system and a thereto connected measurement of the specimen orientation and out of it a correction procedure of the specimen orientation and subsequent automatic approach. However the location of the system is again at the rear side of the knife carrier and is therefore essentially exposed to the same soiling problems from sectioning debris at sectioning, although there is a specific mechanical protection device in place, which then makes the whole system expensive.

DE 195 281 80 C2 is describing a method for an automatic approach system with measurement of the conductivity, when specimen and knife edge are touching each other. This however requires a usable minimum conductivity of the specimen media and embedding media. Those requirements however are only available with frozen section in microtome-cryostats. For practical use, the valuation of the conductivity measurement and herewith related criteria for feed stop will be aligned with temperature tables in order to achieve functionality as secure as possible. For specimen with paraffin embedding media or plastic embedding media this method cannot be used due to missing the minimum of conductivity needed.

All named methods and devices for an approach between specimen and knife edge, those with manual operation as well as those with automatic approach, have in common the disadvantage of lacking functionality and missing inherent safety. This involves that in case of malfunction, caused by an operator as well as in a case of first failure of the utilized technical means, an uncontrolled collision can happen between the specimen and an opposite contact point. This is particularly harmful, because the driving electromotive force of the feed system is acting further until, either by manual intervention or by damaging a technical component, the process comes to an end. The thereby acting forces can be substantial, especially if, as mostly in use, the feed system is working with an electromotive drive together with a spindle and respective nut with fine thread pitch. The ordinary operating parameters of the microtome are then considerably exceeded.

Thereby risk of damage of specimen and/or the knife edge is given to a large extent. Further there is risk of damage of components of the microtome.

With gross operating errors or with a first failure of a technical means, there is in addition to a certain extent the risk of injury, for example bruises at the fingers of the operator.

### BRIEF SUMMARY OF THE INVENTION

It is an objective of the invention to describe a microtome with an electromotive operated feed system and a method for operating such a microtome with that feed system, which, at a high level of functionality, allows manually operated as well as automated feed movements for an approach between specimen and knife edge at set-up procedures and thereby has inherent safety, as with exceeding of a determined collision force between the specimen and an opposite collision point, means will be activated, which will limit the collision force.

Although there are means acting which give inherent safety when exceeding a determined collision force, it is a further objective of the invention, to cause in addition a deactivation of the acting electromotive drive in case of collision and thereto connect procedure steps which lead to an adjustment of the collision situation, in order to enable at a further undisturbed operation a fast and ergonomic functionality of approach between specimen and knife edge.

It is in addition an objective of the invention to develop further the procedure steps in order to realize an automatic approach system between specimen and knife edge while using the identical means.

These objectives are accomplished according to the present invention by a microtome with the characteristics of claim 1. Claims 2 to 9 are describing forms of the microtome according to claim 1. Claims 10 and 11 are describing methods for operating a microtome according to claim 1.

The solution of the problem is based on an analysis of the acting forces and their directions at a sectioning process. In a modification of the force diagram for chipping procedures as described in the so called Orthogonal-Process from Merchant (Zerspantechnik: Prozesse, Werkzeuge, Technologien von Eberhard Paucksch et al.), can be showed, and can be substantiated by practical measurements, that with standard sectioning conditions there is a thrust in opposite to the feed direction, which is caused by shearing and grinding processes at the formation of the section. In the state of the art, this thrust is countered by a zero-backlash bearing of the feed means and in particular a fixed connection, in general a screw connection of, for example, the bearing housing of the feed means with the guidance body of the feed system. Only with a zero-backlash arrangement and a specific rigidity it will be possible at all to generate sectioning results in the thickness range of microns.

That fixed connection, which is applied in the state of the art, between at least one functional part of the interconnected feed means and the guidance body, which is immobile in direction of the feed axis, absorbs the brace force, which is the REACTIO of the mentioned thrust. Thereby it is avoided that by applying thrust at the sectioning process the interconnected feed means may give way and the fed section thickness can be carried out reliably.

The sufficient brace force in order to achieve good sectioning results is however by no means high in respect to the applied sectioning force. Measurements have shown, that the values of brace force acting against the feed direction are in the range of 10-40% of the applied sectioning force, depending on the type of utilized sectioning tool and the type of specimen and specimen embedding media. As result of this analysis follows, that a brace force in feed direction of about 50% of the applied sectioning force is sufficient for normal sectioning applications in order to achieve still confident and good sectioning results. Naturally exempt of this are increased brace forces as they may occur with inadmissible operating parameters at sectioning, for example with collisions in the sectioning path at the sectioning process. The sufficient brace force in feed direction also has to include the REACTIO of friction forces from the feed movement, for example of the linear guidance of the guidance element inside the guidance body.

The solution of this invention is, that the fixed connection of the state of the art instruments which is typically a screw connection between the guidance body of the feed system, which is immobile in feed direction, and the interconnected feed means, now is replaced by a connection which acts only up to a defined limit value of the brace force as a rigid connection with two contact surfaces lying on top of each other and which offers in case of exceedance of that limit value a flexibility opposite to the feed direction.

This now offers the possibility to determine a limit value of brace force in feed direction for the force which may occur at set-up procedures between a specimen and an opposite area of the knife carrier. According to the invention this is solved by having at the guidance body as well as at least at one functional part of the interconnected feed means each a contact surface, whereby the contact surfaces are loaded with a defined force, which is of same absolute value but of opposite direction as the determined limit value for a tolerated force occurring at a collision between the specimen and the knife edge, or a collision point at the knife carrier.

Thereby it is ensured, that with an ongoing feed drive after an occurring collision, for example caused by operation error or by malfunction of technical means of the deactivation circuits, and an exceedance of the determined limit value of the brace force, the interconnected feed means detach from the contact surface at the guidance body. With a further ongoing feed drive at a further existing collision a shift of the interconnected feed means will take place in opposite direction to the feed direction.

When determining the limit value it should be observed, that, depending on the installation position of the feed system, the weight of the interconnected feed means has to be taken in account in addition. As a consequence, for a vertical installation position of the feed system with a vertically directed feed axis, an addition of the weight force of the interconnected feed means has to take place if the feed direction is upwards and a subtraction of the weight force of the interconnected feed means has to take place if the feed direction is downwards. With installation positions of the feed system which are neither horizontal nor vertical, a respective prorated weight force of the interconnected feed means has to be taken in account by trigonometric calculations.

The procedure of shifting of the interconnected feed means will be limited by a self-activating decoupling of reasonable sized and configured components which are relevant in that moving procedure, for example by undo the end of a spindle from the respective feed nut and therefore is limiting the shifting range.

A microtome of that embodiment is inherent safe in relation to occurring collision forces, as with an occurring collision and exceedance of the limit value of the brace force there is no further increase of the collision force in feed direction above the force which is relevant in the shifting range of the interconnected feed means.

An advanced embodiment is, to equip the microtome according to the invention with two switchable limit values of the brace force. This solution takes in account, that the above mentioned thrust, opposite to the feed direction, is only active directly while sectioning. However, if the microtome is in set-up procedure this thrust is not applied and hence there is no need to take it in account when determining the limit value of the brace force. For that operating condition it is sufficient to have a limit value which is above the reaction forces resulting from the friction of coarse feed movements.

This by far lower limit value of the brace force enables a more gently and less risky approach between specimen and knife edge at set-up mode. However, there is a need for the possibility to switch to a higher limit value of the brace force for the sectioning mode, because then there is to take additionally in account the thrust generated at sectioning mode as a counterforce. Otherwise there would be no reliable sectioning process, because the generated thrust would be in the range of the brace force. And therefore it could happen at sectioning, that the contact surfaces of the interconnected feed means and the guidance body would detach from each other. For switching the limit values there are numerous possibilities given. This depends mostly with the technical means used to create the brace force. For example with purely mechanical solutions by a mechanical lever, or with purely electrical solutions by activating of actuators thru the electronic control, or with pneumatic or hydraulic solutions by direct operation of valves, or with more complex solutions by electrical activation of electrically controlled pneumatic or hydraulic valves by the electronic control.

For example, the brace force between guidance body and a thereto attached functional part of the interconnected feed means and the force which is relevant in the shifting range can be created by compression springs or tension springs, whereby one point of force is at the guidance body and one point of force at the opposite functional part of the interconnected feed means. The use of compression springs and tension springs as force generating means is of relative disadvantage, because the force in the shifting range is not constant but increasing up to the disengaging point, even when using very long springs. Thereby it should be remarked, that when selecting the technical design, it should be taken in account, that the finale force at the end of the shifting range should still represent an acceptable collision force in terms of avoiding damages to the specimen or the knife edge.

Therefore it is advantageous, to generate the brace force at the contact surfaces by magnetic force of permanent magnets or electromagnets as force generating means. Thereby also one point of force is at the guidance body and one point of force at the opposite functional part of the interconnected feed means. Conditioned by the decrease of magnetic force with increasing distance between a magnet and a ferromagnetic anchor, or also between two magnets, consequently the force, which is also the collision force, will decrease after exceedance of the limit value with mounting shift as soon as a shift takes place. At this a changeover of the limit values of the brace force can be carried out, for example, by positioning the ferromagnetic anchors at two different distances from the magnets by an actuator.

Respectively other analogue arrangements are possible; the changeover over the distance positions can take place at the part which is related to the guidance body or at the part which is related to the functional part of the interconnected feed means, whereby the single parts can be all magnets or magnets combined with ferromagnetic anchors or other appropriate anchor materials. If the magnets are accomplished as electromagnets, the simplest changeover of the limit values of the brace force is by electrical switching of the coil current.

Further embodiments of force generating means can be, for example, small pneumatic or hydraulic actuators, most common pneumatic or hydraulic cylinders, whereby also there one point of force has to be at the guidance body and one point of force at the opposite functional part of the interconnected feed means. A changeover of the limit values of the brace force, for example, can be performed by switching the applied pressure of the utilized pneumatic or hydraulic actuators. A constant force within the shifting range can be achieved, for example, by using relief valves which are adjusted for a respective pressure

The multitude of possibilities to use as force generating means for the brace force and possibilities for changeover of the limit values of the brace force and to achieve a constant, or falling, or increasing brace force, but only to the extent that the collision force, which is equally strong, does not cause any damage within the shift range, is not yet exhausted with the above named force generating means. The invention includes also those further possibilities as much as they meet the named criteria and the generated force has one point of force at the guidance body and one point of force at the opposite functional part of the interconnected feed means.

When exceeding the applicable limit value of the brace force and with a then beginning shift, the interconnected feed means may tend to a twisting around the feed axis caused by friction forces, especially if there are rotational acting feed means utilized, for example spindle and feed nut. In order to bear and guide the interconnected feed means on the feed axis while shifting it is also with non-rotational acting feed means necessary to take measures, which, especially in regard of the installation position of the respective feed system, can compensate force components, for example, of gravitation force, which are not acting in feed direction or feed counter direction. This is indispensable in regard of a continued functionality after a collision took place and an afterwards reversed collision situation.

A shifting range guidance is therefore generally in place, according to the invention, for all embodiments of interconnected feed means, which guides the interconnected feed means while shifting and protects them against twisting. This can be achieved, for example, for rotational acting feed means by a fixedly connected guiding pin as twist protection, which is mounted at the guidance body parallel to the feed axis in a certain distance. This guiding pin being movable in a drill hole of a functional part of the interconnected feed means in feed direction and feed counter direction, as, for example, a spindle arranged in feed axis ensures that the interconnected feed means together move on the feed axis.

For the shifting range guidance of non-rotational acting interconnected feed means there is, for example, a need of a minimum of two guiding pins in order to achieve the effect or other known guiding elements can be used for achieving a linear guidance and a twist protection as well. When utilizing pneumatic or hydraulic cylinders as force generating means, they could serve for an integrated form of shifting range guidance, because they already include guidance despite their force generating function.

A further embodiment of the microtome consists to that effect, that the condition after an occurred collision and a therefore resulting detachment of the contact surfaces between the guidance body and the interconnected feed means will be detected by switching means and that a deactivation of the electric motor which is driving the feed system will be caused via the electronic control.

Thereby it is of importance, that on the one hand a most immediate detection of the detachment of the contact surfaces takes place and that on the other hand this is carried out with a high reproducibility, because the respective switch-off position is relevant for the accuracy of the method of the further procedure steps. At that it is an aim to achieve a reproducibility of the respective switch-off position with a variation of clearly less than the typical sectioning thickness at first trim sections, for example 30 μm. Simplest, the detecting switching means can be realized by a microswitch, which will be triggered by a mechanical flag. This solution, however, is comparatively inaccurate. The utilization of light barriers, foil pressure sensors, strain gauges or piezo transducers are alternatives as detecting switching means, which, depending on their fineness and the respective application, will satisfy the challenged fast response as well as the wanted high reproducibility

However, the surfaces of, for example, foil pressure sensors or strain gauges cannot directly be used as contact surfaces at the guidance body or at the interconnected feed means, because they do not exhibit the adequate stiffness and therefore section thickness variations would result at sectioning processes with varying thrust under load. With piezo transducers, especially from crystalline material, the given stiffness of, for example 1 μm elongation at 20N brace force of a selected product, will be sufficient for forming directly with the two active areas for one part a contact surface between guidance body and interconnected feed means and for the other part, with the opposite surface, being connected either at the guidance body or at a functional part of the interconnected feed means and herewith fulfill the function of a detecting switching means.

A further and more economic version of detecting switching means is consisting by using essential functional parts of the fitting and constituting them as switching means simply by selection of material and configuration. Thereto the contact surfaces lying on each other of on one hand the guidance body and the other hand a functional part of the interconnected feed means, for example, could be thought of as two electrical contacts lying on each other, which would separate at a collision and followed commencing shift and therefore send a signal to the electronic control. However, thereto it is mandatory, that the two contact surfaces can embrace different electrical potentials after separation. This, for example, can be achieved by a guidance body, or a part of the guidance body, being made of electrically non-conducting material and a therein inserted conducting ring or one or several conducting pins to provide an electrical and mechanical contact surface.

The same possibility is consisting naturally in reverse by choosing a non-conducting material for that functional part of the interconnected feed means designated as surface contact and to insert into that material a conducting ring or one or several conducting pins to provide an electrical and mechanical contact surface. There is a necessity to choose non-conducting material for one of the two of the carrier parts of the contact surfaces, because commonly all further parts of the feed system consist of metals and therefore would existing an electrical connection via linking guidance, joints or bearings even after a commencing shift and separation of the contact surfaces.

The further solution of the problem according to the invention is achieved by a method for operating a microtome by a sequence of procedural steps, which are actuated by the electronic control. For this purpose, the feed position, which is accumulated in respect of an initialisation position at power up of the microtome, will be determined and stored at the moment of deactivation of the electric motor caused by the detecting switching means. Immediately after this the electric motor will be activated again, but in reverse direction, and conducts a movement which is laid down in the electronic control and leads to a safe rectification of the collision.

The solution of the problem consists herewith in realizing an automatic approach between specimen and knife edge by using further procedural steps based on the so far mentioned partial solution steps. To do so, the electronic control is verifying if an automatic approach was initiated via the control panel. In a next step the electronic control is checking the position of the support body. The therefore necessary information is commonly available at the electronic control, because information about start of the sectioning path and end of the sectioning path is needed also for regular application mode. If the support body, which can be moved by the sectioning drive, is positioned at the end of the sectioning path, a feed movement will be conducted which continues up to an intended collision between the specimen and the knife carrier body beyond the knife edge. Expediently a flat surface is located at the knife carrier body, which is oriented vertical in regard to the feed direction and which is offset in regard to the knife edge by a certain distance.

With a then occurring collision a deactivation of the electric motor takes place via the mentioned means. The distance in feed direction between the collision surface at the knife carrier body and the knife edge is set as knife carrier reference value and this value is stored in the electronic control. In addition at the electronic control is stored a value for safety retraction. Both values must be added and the resulting value for movement will be carried out in opposite direction to the feed direction by activation of the electric motor. With that the collision is dissolved and the specimen is located within the distance of the safety retraction ahead of the knife edge. The procedure of automatic approach will be finished as soon as the electronic control will detect the position of the support body, which can be moved by the sectioning drive, in the start position of the sectioning path. Then the electric-motor will be activated in feed direction for a movement which is of same magnitude as the safety retraction and therefore is neutralizing the safety retraction. Now the specimen is in trim position in regard to the feed position as well as in regard to the sectioning path.

The described solution for a configuration of the feed system of a microtome and the thereto matching procedural steps of a method to operate a microtome can be applied to all types of microtomes mentioned at the beginning, likewise in cryostat microtome versions, whether the respective type of microtome in regards to the feed system is configured with knife carrier feed system or specimen feed system at that. As electric motors for driving the feed system all types of motors can be utilized which are permitting to reverse the direction by the control, especially also linear motors. At that, depending on the type of motor, an additional position measurement device for measuring the respective feed position, being connected to the electronic control, will be mandatory for applying the described method. The utilization of stepping motors is facilitating an economically advantageous solution, as with that a position feedback control is not needed

### BRIEF DESCRIPTION OF THE SEVERAL VIEWS OF THE DRAWINGS

Further advantages and embodiments of the microtome according to the invention as well as the methods for operation of such a microtome ensue from the following figures and their descriptions.

In particular FIG. 1a up to FIG. 5b shows microtomes according the state of the art, always without housing, in different embodiments but with feed systems of generally the same kind. FIG. 6a and FIG. 6b shows graphics of force effects in sectioning mode and with collision in set-up mode. The FIGS. 7a up to 9c show embodiments of the microtome according to the invention and FIGS. 10a up to 11k outline the methods for operation according to the invention of the microtome according to the invention. For components which are connected to each other the representation of the respective fasteners was spared for reasons of clarity, to the extent the type of connection is irrelevant for the invention.

The drawings illustrate in

FIG. 1a a rocking microtome with knife carrier feed system according the state of the art

FIG. 1b a longitudinal section thru a rocking microtome with knife carrier feed system according the state of the art

FIG. 2 a sledge microtome with specimen feed system according the state of the art

FIG. 3 a disk microtome with knife carrier feed system according the state of the art

FIG. 4a a rotary microtome with knife carrier feed system according the state of the art

FIG. 4b a longitudinal section thru a rotary microtome with knife carrier feed system according the state of the art

FIG. 5a a rotary microtome with specimen feed system according the state of the art

FIG. 5b a longitudinal section thru a rotary microtome with specimen feed system according the state of the art

FIG. 6a a schematic depiction of force effects in sectioning mode

FIG. 6b a schematic depiction of force effects in the case of collision between knife edge and specimen with a microtome according to the invention

FIG. 7a a microtome with specimen feed system according to the invention

FIG. 7b a microtome with specimen feed system according to the invention after an occurred collision

FIG. 7c an exploded view of a feed system of a microtome according to the invention with springs for generating the brace force

FIG. 7d an exploded view of a feed system of a microtome according to the invention with magnets for generating the brace force

FIG. 7e a longitudinal section thru a microtome according to the invention with magnets for generating the brace force

FIG. 7f a longitudinal section thru a microtome according to the invention after an occurred collision with magnets for generating the brace force

FIG. 7g an exploded view of a feed system of a microtome according to the invention with magnets for generating the brace force and with changeover of the limits of the brace force

FIG. 7h a rear view of a feed system of a microtome according to the invention with magnets for generating the brace force and with changeover of the limits of the brace force, in a first position of the changeover means

FIG. 7i a longitudinal section thru a feed system of a microtome according to the invention with magnets for generating the brace force and with changeover of the limit values of the brace force, in a first position of the changeover means

FIG. 7j a rear view of a feed system of a microtome according to the invention with magnets for generating the brace force and with changeover of the limits of the brace force, in a second position of the changeover means

FIG. 7k a longitudinal section thru a feed system of a microtome according to the invention with magnets for generating the brace force and with changeover of the limit values of the brace force, in a second position of the changeover means

FIG. 8a a longitudinal section thru a microtome according to the invention with magnets for generating the brace force and with a piezo transducer as detecting switching means

FIG. 8b a magnified detail of a longitudinal section thru a feed system of a microtome according to the invention with magnets for generating the brace force and with a piezo transducer as detecting switching means

FIG. 9a a longitudinal section thru a microtome according to the invention with magnets for generating the brace force and with integrated detecting switching means

FIG. 9b an exploded view of a feed system of a microtome according to the invention with magnets for generating the brace force and with integrated detecting switching means

FIG. 9c a magnified detail of a longitudinal section thru a feed system of a microtome according to the invention with magnets for generating the brace force and with integrated detecting switching means

FIG. 10a a flow chart of a routine in the electronic control of the microtome according to the invention for controlling the switch-off function at a beginning shift after a collision and for rectification of a collision

FIG. 10b a microtome according to the invention previous to a set-up procedure

FIG. 10c a microtome according to the invention with an occurred collision at a set-up procedure

FIG. 10d a magnified detail of knife edge and specimen with an occurred collision

FIG. 10e a microtome according to the invention after a rectification of a collision

FIG. 10f a magnified detail of knife edge and specimen after a rectification of a collision

FIG. 11a a flow chart of a routine in the electronic control of the microtome according to the invention for executing an automatic approach between knife edge and specimen

FIG. 11b a microtome according to the invention positioned at the end of the sectioning path before starting an automatic approach between knife edge and specimen

FIG. 11c a magnified detail of knife edge and specimen previous to starting an automatic approach procedure

FIG. 11d a microtome according to the invention positioned at the end of the sectioning path at an automatic approach procedure between knife edge and specimen at the collision with the knife carrier reference surface

FIG. 11e a magnified detail of knife edge and specimen at an automatic approach procedure in the state of collision with the knife carrier reference surface

FIG. 11f a microtome according to the invention positioned at the end of the sectioning path at an automatic approach procedure between knife edge and specimen after rectification of the collision with the knife carrier reference surface

FIG. 11g a magnified detail of knife edge and specimen at an automatic approach procedure after rectification of the collision with the knife carrier reference surface

FIG. 11h a microtome according to the invention positioned at the start of the sectioning path at an automatic approach procedure between knife edge and specimen in the state of safety retraction

FIG. 11i a magnified detail of knife edge and specimen at an automatic approach procedure in the state of safety retraction

FIG. 11j a microtome according to the invention positioned at the start of the sectioning path past finalizing an automatic approach procedure between knife edge and specimen

FIG. 11k a magnified detail of knife edge and specimen past finalizing an automatic approach procedure between knife edge and specimen

### DETAILED DESCRIPTION OF THE INVENTION

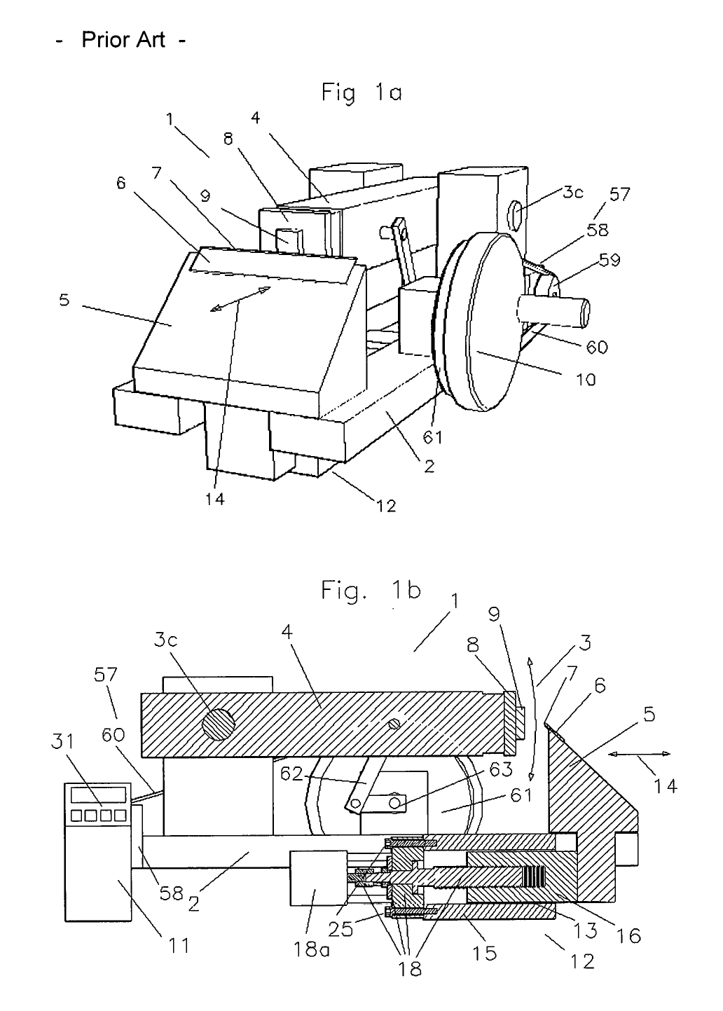

FIG. 1a shows a perspective view of a rocking microtome with knife carrier feed system according to the state of the art. The main body 2 of the microtome 1 bears the support body 4, which is serving as rocking arm and is pivoted in the rocking arm bearing 3c. The sectioning tool 6 is connected to the knife carrier 5. To simplify the illustration the embodiment of a so-called magnetic knife carrier is shown here, as with all further depictions, whereby the sectioning tool 6 is fixed in its position by flush-mounted permanent magnets, not illustrated here. The knife carrier 5 is shown here, and with all further depictions, as being of one piece for simplification. Practically in use are knife carriers which, for example, are consisting of a support part, a knife carrier base part with the option for positioning and a knife carrier top part with the option for clearance angle adjustment. Since these characteristics are not affecting the invention they are neglected and the knife carrier 5 is depicted simplified. Opposite to the knife edge 7 of the sectioning tool 6 is located the specimen holder 8 with a thereto connected specimen 9 and together fixed to the support body 4. The specimen holder 8 is here also, as with all further depictions, illustrated as being of one piece for simplification. Practically in use are specimen holders which, for example, include adjustment means for specimen orientation and for the attachment of in-between devices to enable best fitting regarding specimen shape and specimen size. Since these characteristics are not affecting the invention they are neglected and the specimen holder 8 is depicted simplified. The sectioning drive 10 serves for the production of sections of the microtome 1. The feed system 12, which can move the knife carrier 5 in direction of double arrow feed movement 14 forward and backward, serves for approach between specimen 9 and knife edge 7.

FIG. 1b shows a longitudinal section thru the rocking microtome which is shown in FIG. 1a. A feed system 12 according to the state of the art is here illustrated with its main components. In this example, the guidance body 15 is firmly connected with the main body 2. Inside the guidance body 15 the guidance element 16 can move along the linear guidance 13 and is, in this example, firmly connected to the knife carrier 5. The interconnected feed means 18 are firmly connected to the guidance body 15 by one of their functional parts. Thereby that firm connection may be effected via fastening screws 25, as illustrated here, or to implement the functional part as one piece with the guidance body 15. The interconnected feed means 18 which are shown here comprise a spindle, a spindle bearing with its individual parts and a coupling to the electric motor, as well as the electric motor 18a itself and its fastening parts. Further embodiments of feed means may be present in the form of rack and pinion drives, lever arrangements or wire rope hoist assemblies.

Common to all embodiments is the existence of a functional part, which, for example, is serving as fitting, mounting or bearing housing of the other interconnected feed means 18 and which exhibits a firm connection to the guidance body 15.

FIG. 1b also illustrates how the sectioning drive 10 is moving the support body 4 and with it the specimen holder 8 and the specimen 9 on a segment of a circular orbit around the rocking arm bearing 3c. This is indicated by double arrow 3, which is describing the sectioning path.

The sectioning drive of the microtome is shown here in a generic way. With all further depictions of other types of microtomes the illustration of the sectioning drive will be neglected, since it is of no importance for the object of the invention. Solely the sectioning path will be depicted respectively.

The electronic control 11 with the control panel 31 is at least connected to the electric motor 18a. That electrical connection is not illustrated here. With an activation of the electric motor 18a in feed direction by the electronic control 11, the further interconnected feed means 18 are effecting a movement of the knife carrier 5 which is connected to the guidance element 16 and herewith a movement of the knife edge 7 towards the specimen 9. If a deactivation in due time does not take place, caused by an operation error or by a first failure of a technical means, an uncontrolled collision will occur between knife edge 7 and specimen 9 with consequences of damage.

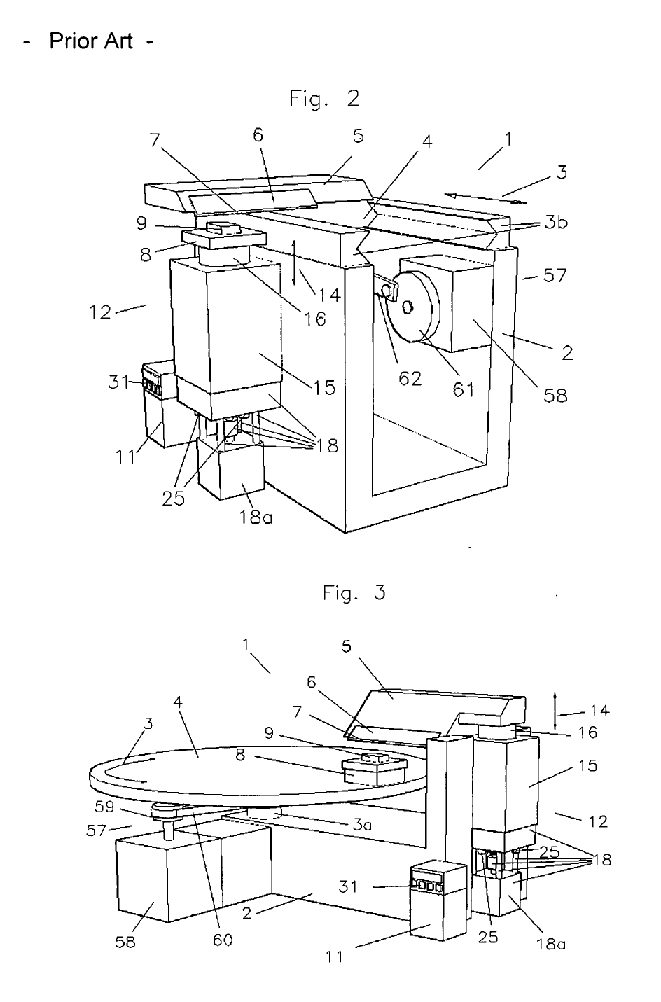

FIG. 2 shows a sledge microtome with specimen feed system according to the state of the art in a perspective view. Connected to the main body 2 of the microtome 1 is the guidance of sectioning path 3b. The support body 4 can be moved on the sectioning path in direction of double arrow 3 along the guidance of sectioning path 3b. Connected to the support body 4 is the knife carrier 5, to which the sectioning tool 6 is attached which exhibits the knife edge 7. In this example, the feed system 12 is connected via the guidance body 15 laterally to the main body 2. The moveable guidance element 16 of the feed system 12 can accomplish the feed movement in direction of double arrow 14. Connected to the upper ending of the guidance element 16 is the specimen holder 8, which holds the specimen 9.

The electronic control 11 with the control panel 31 is at least connected to the electric-motor 18a. This electrical connection is not illustrated here.

With an activation of the electric motor 18a in feed direction by the electronic control 11, the further interconnected feed means 18 are effecting a movement of the specimen holder 8 which is connected to the guidance element 16 and herewith a movement of the specimen 9 towards the knife edge 7. If a deactivation in due time does not take place, caused by an operation error or by a first failure of a technical means, an uncontrolled collision will occur between knife edge 7 and specimen 9 with consequences of damage.

FIG. 3 shows in a perspective view a disk microtome with knife carrier feed system according to the state of the art. Connected to the main body 2 of the microtome 1 is the disk bearing 3a. Around that, the guidance body 4, which has here the shape of a disk, can move on a circular sectioning path in direction of double arrow 3. Connected to the support body 4 is the specimen holder 8, which holds the specimen 9. In this example, the feed system 12 is connected via the guidance body 15 laterally to the main body 2. The moveable guidance element 16 of the feed system 12 can accomplish the feed movement in direction of double arrow 14. Connected to the upper ending of the guidance element 16 is the knife carrier 5, to which the sectioning tool 6 is attached which exhibits the knife edge 7.

The electronic control 11 with the control panel 31 is at least connected to the electric motor 18a. That electrical connection is not illustrated here.

With an activation of the electric motor 18a in feed direction by the electronic control 11, the further interconnected feed means 18 are effecting a movement of the knife carrier 5 which is connected to the guidance element 16 and herewith a movement of the knife edge 7 towards the specimen 9. If a deactivation in due time does not take place, caused by an operation error or by a first failure of a technical means, an uncontrolled collision will occur between knife edge 7 and specimen 9 with consequences of damage.

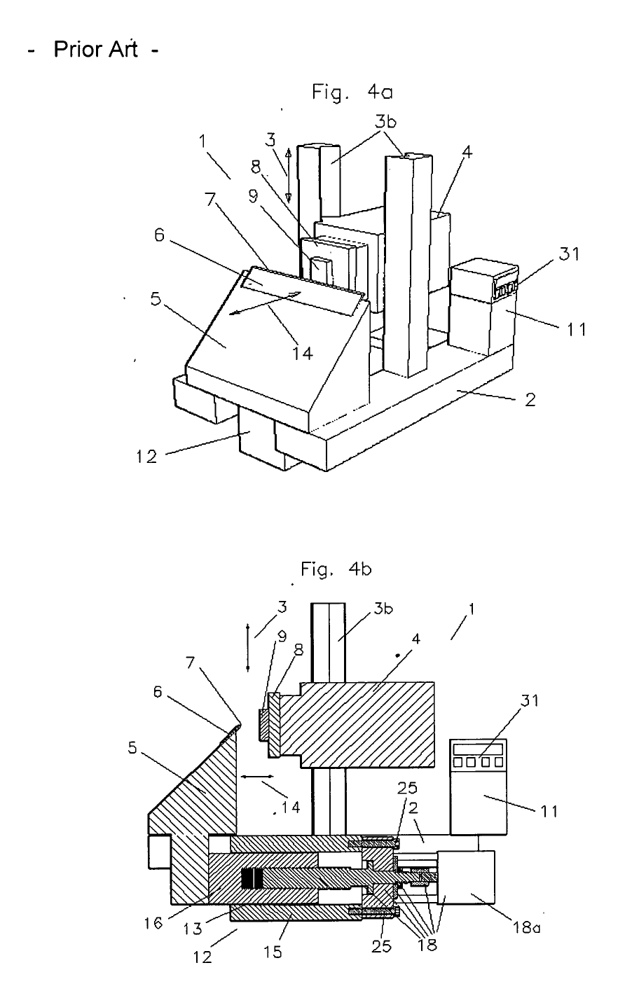

FIG. 4a shows a perspective view of a rotary microtome with knife carrier feed system according to the state of the art. Connected to the main body 2 of the microtome 1 is the guidance of sectioning path 3b in which the support body 4 is moveable along the sectioning path, indicated with double arrow 3. The support body 4 carries the specimen holder 8 with the thereto attached specimen 9. The knife carrier 5 is connected to the feed system 12. Connected to the knife carrier 5 is the sectioning tool 6, which exhibits the knife edge 7. The feed system 12, which can move the knife carrier 5 forward and backward in direction of double arrow for feed movement 14, serves for approach between the specimen 9 and the knife edge 7. The electronic control 11 with the control panel 31 is electrically connected with the feed system 12. This electrical connection is not shown here for simplicity.

FIG. 4b shows a longitudinal section thru the rotary microtome of FIG. 4a. Depicted is a feed system 12 with its main components according to the state of the art. In this example, the guidance body 15 is firmly connected to the main body 2. Inside the guidance body 15, the guidance element 16, which is firmly connected to the knife carrier 5, is moveable along the linear guidance 13. The interconnected feed means 18 are firmly connected to the guidance body 15 with one of their functional parts. Thereby this firm connection can take place via fastening screws 25, as shown here, or by accomplishing the respective functional part in one piece with the guidance body 15.

The interconnected feed means 18 which are shown here comprise a spindle, a spindle bearing with its individual parts and a coupling to the electric motor 18a, as well as the electric motor 18a itself and its fastening parts. Further embodiments of feed means may be present in the form of rack and pinion drives, lever arrangements or wire rope hoist assemblies.

Common to all embodiments is the existence of a functional part, which, for example, is serving as fitting, mounting or bearing housing of the other interconnected feed means 18 and which exhibits a firm connection to the guidance body 15.

The electronic control 11 with the control panel 31 is at least connected to the electric motor 18a. That electrical connection is not illustrated here.

With an activation of the electric motor 18a in feed direction by the electronic control 11, the further interconnected feed means 18 are effecting a movement of the knife carrier 5 which is connected to the guidance element 16 and herewith a movement of the knife edge 7 towards the specimen 9.

If a deactivation in due time does not take place, caused by an operation error or by a first failure of a technical means, an uncontrolled collision will occur between knife edge 7 and specimen 9 with consequences of damage.

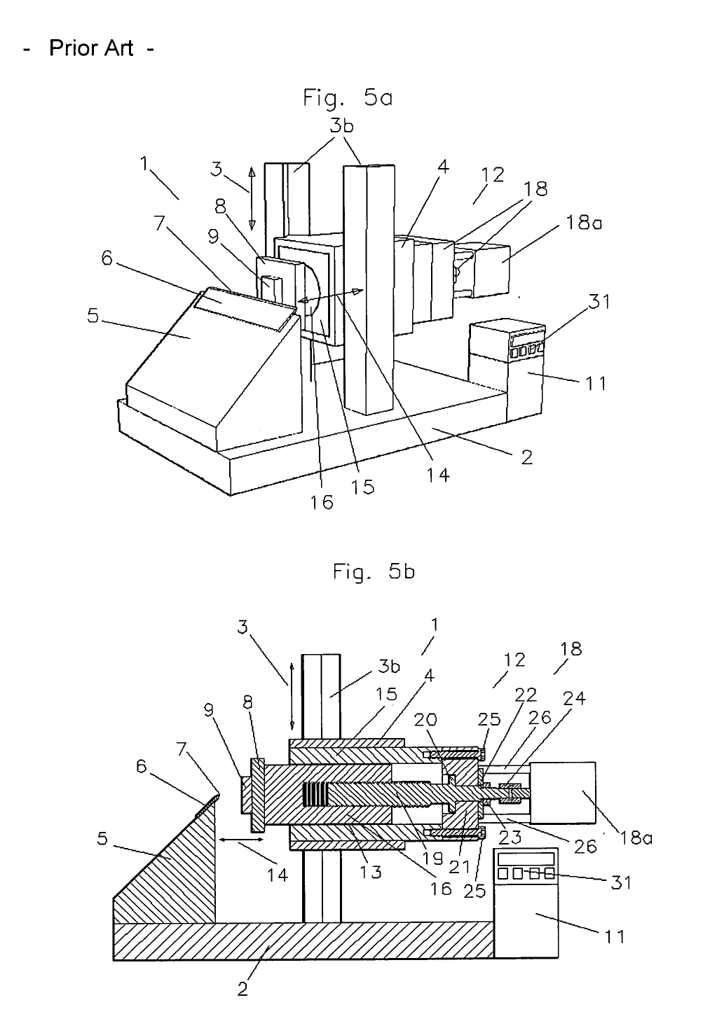

FIG. 5a shows a perspective view of a rotary microtome with specimen feed system according to the state of the art. Connected to the main body 2 of the microtome 1 is the guidance of sectioning path 3b in which the support body 4 is moveable along the sectioning path, indicated with double arrow 3. The knife carrier 5 is firmly connected to the main body 2. Attached to the knife carrier 5 is the sectioning tool 6, which exhibits the knife edge 7. The support body 4 carries the feed system 12, which supports at the front end the specimen holder 8 with the thereto attached specimen 9. The feed system 12, which can move the specimen holder 8 with attached specimen 9 forward and backward in direction of double arrow for feed movement 14, serves for approach between the specimen 9 and the knife edge 7. The electronic control 11 with the control panel 31 is electrically connected with the feed system 12. This electrical connection is not shown here for simplicity.

FIG. 5b shows a longitudinal section thru the rotary microtome of FIG. 5a. Depicted is a feed system 12 with its main components according to the state of the art. In this example, the guidance body 15 is firmly connected to the support body 4 which is moveable along the sectioning path indicated by double arrow 3. Inside the guidance body 15, the guidance element 16, which is firmly connected to the specimen holder 8 with attached specimen 9, is moveable along the linear guidance 13. The interconnected feed means 18 are firmly connected to the guidance body 15 with one of their functional parts, which is in the example the spindle bearing 21. Thereby this firm connection can take place via fastening screws 25, as shown here, or by accomplishing the respective functional part, here the spindle bearing 21, in one piece with the guidance body 15.

The interconnected feed means 18 which are shown here comprise a spindle 19 with a spindle flange 20, a spindle bearing 21, a bearing disk 22, a spindle bearing nut 23 and a shaft coupling 24 to the electric motor 18a, as well as the electric motor 18a itself and its mounting rods 26. Further embodiments of feed means may be present in the form of rack and pinion drives, lever arrangements or wire rope hoist assemblies.

Common to all embodiments is the existence of a functional part, which, for example, is serving as fitting, mounting or bearing housing of the other interconnected feed means 18 and which exhibits a firm connection to the guidance body 15.

The electronic control 11 with the control panel 31 is at least connected to the electric motor 18a. That electrical connection is not illustrated here.

With an activation of the electric motor 18a in feed direction by the electronic control 11, the further interconnected feed means 18 are effecting a movement of the specimen holder 8 with attached specimen 9 which is connected to the guidance element towards the knife edge 7.

If a deactivation in due time does not take place, caused by an operation error or by a first failure of a technical means, an uncontrolled collision will occur between knife edge 7 and specimen 9 with consequences of damage.

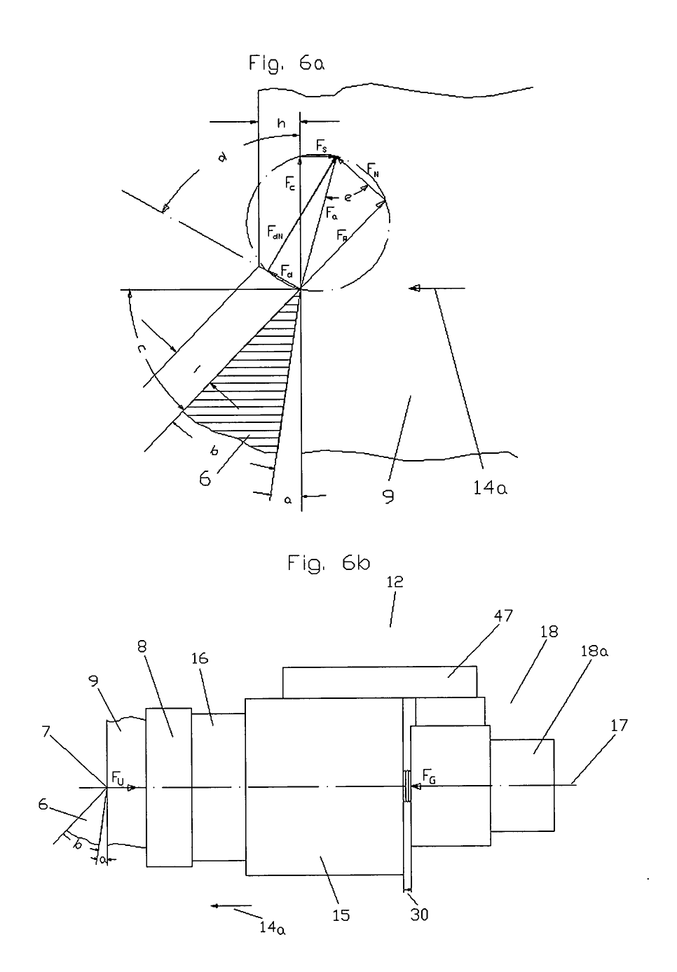

FIG. 6a shows a schematic diagram of the force effects at a sectioning process, which is derived from the Orthogonal Process by Merchant (Orthogonalprozess nach Merchant) which is known in literature for cutting processes. It is illustrated how the sectioning tool penetrates into the specimen material with its wedge angle b, keeping a clearance angle a, and with a feed thickness h, and how thereby a section with the cutting thickness i is sliding on the rear of the sectioning tool under a cutting angle c. Relevant for the difference in thickness between feed thickness h and the effective cutting thickness i are compressions by shear forces and friction forces at the section formation, which are characterized in the partition of forces by shear angle d and friction angle e. The active force Fₐ, acting on the specimen material, has to overcome the shear forces as well as the friction forces. In detail is F_{d} the shear force in the shear plane and F_{dN} the shear normal force, which is perpendicular thereto. F_{R} is the cutting plane friction force and F_{N} is the normal force perpendicular thereto. The active force Fₐ is partitioned into the components, which is the cutting force F_{c} opposite to the sectioning direction and thereto perpendicular the thrust Fₛ opposite to the feed direction. At a minimum it is necessary to brace this thrust Fₛ in order to avoid an evasion of the section material opposite to the feed direction at the sectioning process, or by inversion of the conditions, to avoid an evasion of the sectioning tool. That is the precondition for an application-based section formation process.

FIG. 6b shows a schematic diagram of the force effects in set-up mode with an occurred collision between knife edge 7 and specimen 9 without switching off the electric motor 18a and therefore, according to the invention, resulting shift 30 of the interconnected feed means 18 in feed axis 17 along the guidance of the shifting range 47. Thereby is the absolute value of the collision force F_{K} of same amount as the limit value of the brace force F_{G}, however of opposite direction. At that the force F_{G} is chosen, that it is on one hand admittedly stronger than the thrust Fₛ from FIG. 6a, which occurs in sectioning mode, in order to enable an application-based sectioning process, but on the other hand to be weak enough to limit the collision force F_{K} to values, which would as much as possible avoid to provoke any damages. For example, F_{G} can be chosen as F_{G}=1,5×Fₛ.

In case of a switchable limit value of the brace force F_{G} and depending on whether sectioning mode or set-up mode is present, the thrust Fₛ from FIG. 6a can be neglected, as it is only occurring in sectioning mode. Therefore a very small value for F_{G} can be determined in set-up mode, which must be merely larger than the sum of the inner friction forces of the interconnected feed means 18 between themselves and the friction force of the guidance between guidance body 15 and guidance element 16. The diagram shows that the absolute value of F_{K} is limited to F_{G} and therefore inherent safe in regard of avoidance of a collision force F_{K} which would be above the determined limit value of the brace force F_{G}.

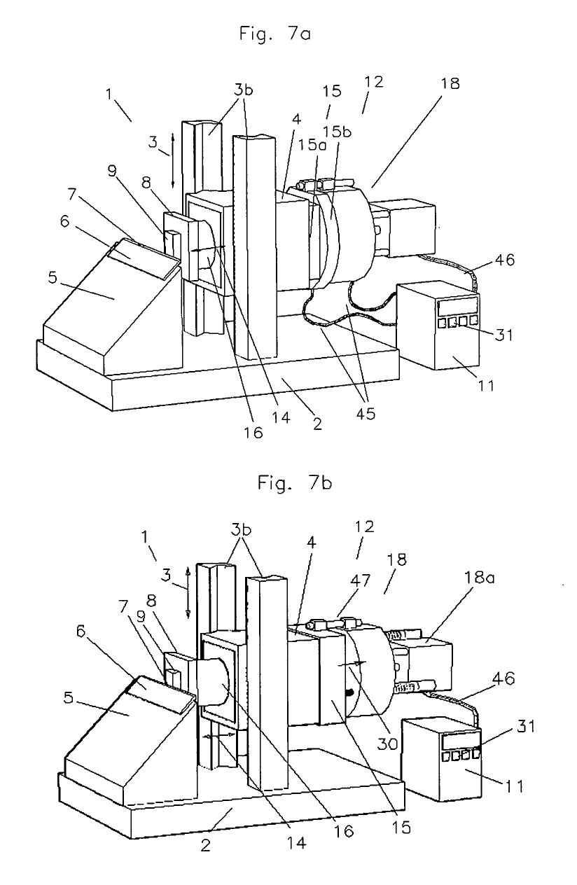

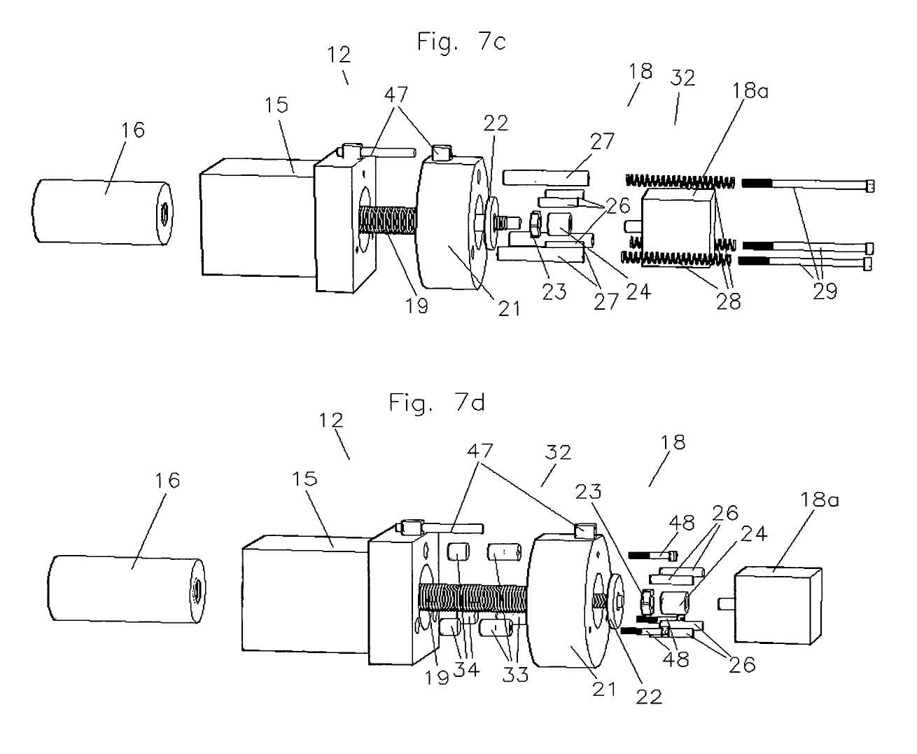

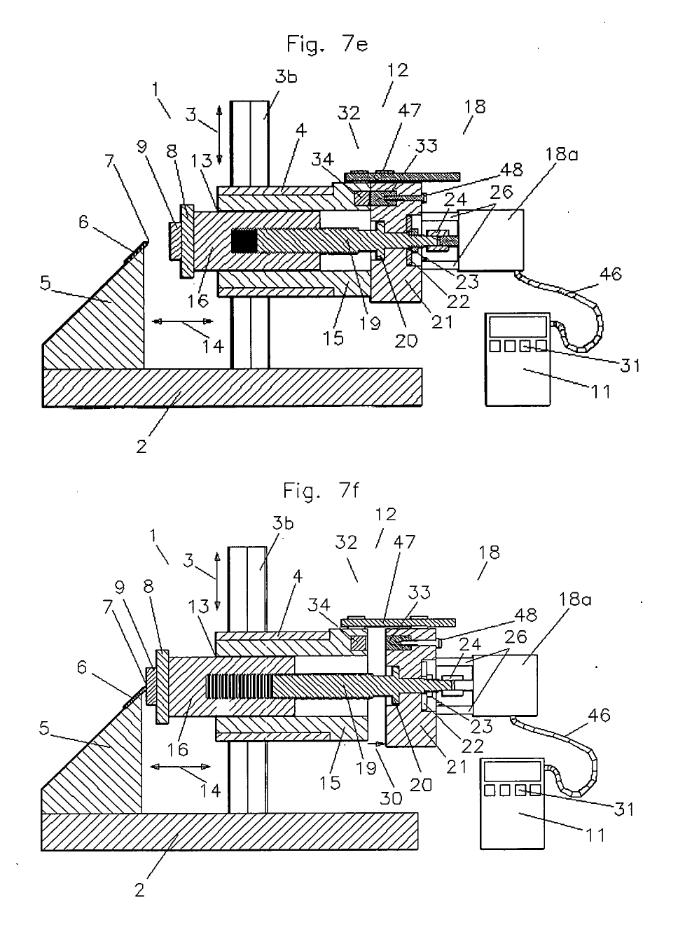

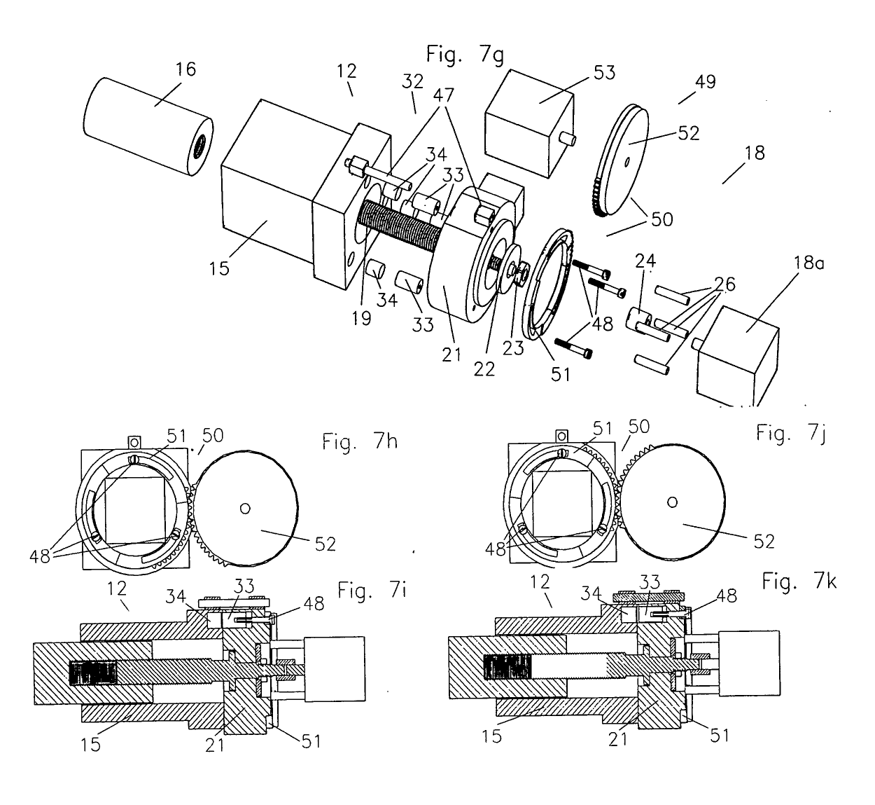

FIG. 7a shows in a perspective view a microtome 1 according to the invention, —without housing parts—, with specimen feed system in sectioning mode or in set-up mode. Connected to the main body 2 is the guidance of sectioning path 3b along which the support body 4 is moveable in direction of double arrow sectioning path 3. The knife carrier 5 is connected to the main body 2 and carries the sectioning tool 6 with knife edge 7. The feed system 12 is firmly connected with the support body 4 via its guidance body 15. The specimen holder 8 with attached specimen 9 is connected to the guidance element 16, which can perform the feed movement of the feed system 12, indicated with double arrow 14. The interconnected feed means 18 fit close to the guidance body 15 with a defined force. The electronic control 11 with the control panel 31 is connected to the feed system 12 via the motor cable 46 to the electric motor 18a, which is part of the interconnected feed means 18.

FIG. 7b shows in a slightly rotated view the microtome 1 of FIG. 7a with an occurred collision in set-up mode. An uncontrolled feed movement 14 caused by an operation error or by a first failure of technical means leads to a collision between specimen 9 and knife edge 7. With continued operation of the electrical motor 18a a shift 30 of the interconnected feed means 18 is commencing at the exceedance of the limit value of the brace force. This shift is leading away from the guidance body 15 along the guidance of the shifting range 47.

FIG. 7c shows an exploded view of a feed system 12 of a microtome according to the invention with springs 28 as part of the force generating means 32 for generating the brace force.

The parts of the feed system 12 are: the guidance element 16, the guidance body 15, the guidance shifting range 47, the force generating means 32 and the interconnected feed means 18, which themselves, in this embodiment consist of: the electrical motor 18a, the spindle 19, the spindle bearing 21, the bearing disk 22, the spindle bearing nut 23, the shaft coupling 24 and the mounting rods 26. In this example, the force generating means 32 are the springs 28, the spring sleeves 27 and the spring rods 29. In assembled condition the spring rods 29 are screwed-in to the guidance body 15 and therefore stationary at a shift. The springs 28 are supported on one side at the head of the spring rods 29 and on the other side at the bottom of the blind holes at the spindle bearing 21. With that the spindle bearing 21 is pressed with the force of the pre-stressed springs 28 against the guidance body 15. The spring sleeves 27 are simply serving for a better duct of the springs 28 and are connected to the spindle bearing 21.

FIG. 7d shows an exploded view of a feed system 12 of a microtome according to the invention with magnets 34, which are shown here as permanent magnets, as part of the force generating means 32 for generating the brace force.

The parts of the feed system 12 are: the guidance element 16, the guidance body 15, the guidance shifting range 47, the force generating means 32 and the interconnected feed means 18, which themselves, in this embodiment consist of: the electrical motor 18a, the spindle 19, the spindle bearing 21, the bearing disk 22, the spindle bearing nut 23, the shaft coupling 24 and the mounting rods 26. In this example, the force generating means 32 are the magnets 34 with the ferromagnetic anchor plates 33 and the positioning screws 48.

In assembled condition the magnets 34 are connected at the guidance body 15, for example by gluing together, and therefore they are stationary at a shift. The ferromagnetic anchor plates 33 are hold in position in the spindle bearing 21 by the positioning screws 48. Caused by the magnetic force which is acting between the magnets 34 and the ferromagnetic anchor plates 33, the spindle bearing 21 is pressed against the guidance body 15 by a defined force.

FIG. 7e shows a longitudinal section thru a microtome 1, in sectioning mode or in set-up mode, according to the invention with magnets 34 as part of the force generating means 32 for generating the brace force. The main body 2 is firmly connected to the guidance of sectioning path 3b along which the support body 4 is moveable in direction of double arrow sectioning path 3. Likewise connected to the main body 2 is the knife carrier 5 which carries the sectioning tool 6 with the knife edge 7. The feed system 12, which corresponds to the embodiment shown in FIG. 7d, is firmly connected via the guidance body 15 to the support body 4. The specimen holder 8 with attached specimen 9 is connected to the guidance element 16, which can perform the feed movement of the feed system 12, indicated with double arrow 14. The interconnected feed means 18, consisting of the spindle 19, the spindle flange 20, the spindle bearing 21, the bearing disk 22, the spindle bearing nut 23, the shaft coupling 24, the mounting rods 26 and the electrical motor 18a are pressed with the brace force via the spindle bearing 21 against the guidance body 15. The force generating means 32, consisting of the magnets 34, the ferromagnetic anchor plates 33 and the positioning screws 48, determine by their characteristics and adjustments the value of the brace force. The guidance of the shifting range 47 is shown in this operating state as unmoved, because the interconnected feed means 18 are pressed against the guidance body 15 with the brace force of the force generating means 32. With activation of the electrical motor 18a by the electronic control 11 and the control panel 31 via the motor cable 46, the feed movement 14 will be carried out by the spindle 19 acting on the nut thread at the guiding element 16.

FIG. 7f shows a longitudinal section thru a microtome 1, in set-up mode, according to the invention, at an occurred collision and with magnets 34 as part of the force generating means 32 for generating the brace force. The main body 2 is firmly connected to the guidance of sectioning path 3b along which the support body 4 is moveable in direction of double arrow sectioning path 3. Likewise connected to the main body 2 is the knife carrier 5 which carries the sectioning tool 6 with the knife edge 7. The feed system 12 is firmly connected via the guidance body 15 to the support body 4. The specimen holder 8 with attached specimen 9 is connected to the guidance element 16, which can perform the feed movement along the linear guidance 13, indicated with double arrow 14. This depiction illustrates a collision situation where the specimen 9 is in contact with the knife edge 7. With the depicted operating state, the interconnected feed means 18, consisting of the spindle 19, the spindle flange 20, the spindle bearing 21, the bearing disk 22, the spindle bearing nut 23, the shaft coupling 24, the mounting rods 26 and the electric motor 18a, are shifted by the shift indicated with arrow 30 along the guidance of the shifting range 47. The force generating means 32, consisting of the magnets 34, the ferromagnetic anchor plates 33 and the positioning screws 48, determine with their characteristics and their adjustments also the existing force between guidance body 15 and interconnected feed means 18 on the shifting path while a shift 30 takes place and thus the collision force acting on the shifting path. Thereby the magnets are located stationary at the guidance body 15, while the ferromagnetic anchor plates 33, which are hold by the positioning screws 48 at the spindle bearing 21, are moving with the shift 30. With continued activation of the electrical motor 18a by the electronic control 11 and the control panel 31 via the motor cable 46, the shift 30 goes on thru spindle 19 and the nut thread at the guidance element 16 at an existing collision between specimen and knife edge. Thereby the interconnected feed means 18 are further moving along the guidance of the shifting range 47 until, for example, the spindle ending disengages from the nut thread at the guidance element 16 and therefore the movement comes to an end. In this example, is the magnetic force between guidance body 15 and the interconnected feed means 18 steady decreasing and therefore also the collision force on the shifting path while a shift 30 takes place.

FIG. 7g shows an exploded view of a feed system 12 of a microtome according to the invention with magnets 34, which are depicted here as permanent magnets, as part of the force generating means 32 for generating the brace force and additionally with changeover means 49 for changeover of the brace force. The components of the feed system 12 are: the guidance element 16, the guidance body 15, the guidance shifting range 47, the force generating means 32 and the interconnected feed means 18, which themselves in this embodiment consist of: the electrical-motor 18a, the spindle 19, the spindle bearing 21, the bearing disk 22, the spindle bearing nut 23, the shaft coupling 24 and the mounting rods 26. In this example, the force generating means are the magnets 34 with the ferromagnetic anchor plates 33 and the positioning screws 48. In assembled condition the magnets 34 are connected at the guidance body 15, for example by gluing together, and therefore they are stationary at a shift. The ferromagnetic anchor plates 33 are hold in position in the spindle bearing 21 by the positioning screws 48, whereby the positioning screws 48 brace themselves at the segment ring 51, which itself fits closely to the spindle bearing 21. Caused by the magnetic force which is acting between the magnets 34 and the ferromagnetic anchor plates 33, the spindle bearing 21 is pressed against the guidance body 15 by a defined force. In this example, the segment ring 51 has 3 segments of 120° each, which have each on one side a helicoidal thickening whereas the other side is a flat contact surface. The mentioned three segments are punctuated by slots, thru which, in a functional and assembled condition, the positioning screws 48, which hold the ferromagnetic anchor plates 33, protrude and brace themselves with their head at the helicoidal segment areas. By rotating the segment ring 51, the ferromagnetic anchor plates 33 are moved axially back and forth corresponding to the thickening or tapering at the position where the positioning screws are protruding thru the slots, and therefore the acting magnetic force between the guidance body 15 and the interconnected feed means 18, which acts as brace force, is changed. In this same depicted example, the segment ring 51 is rotatable by a pinion 52, which is actuated by an actuator 53, and thus effect a changeover of the brace force.

FIG. 7h shows, referring to the depiction in FIG. 7g, a rear view of a feed system 12 of a microtome according to the invention with changeover of the limit values of the brace force in the status of a first changeover position. The actuating means 50, consisting of the segment ring 51 and the pinion 52, are in engagement with each other. The positioning screws 48 protrude thru the slots at the segment ring 51 and brace themselves with their head at the thinner zone of each of the helicoidal thickening segments.

FIG. 7i shows, referring to the depiction in FIG. 7g, a longitudinal section thru a feed system 12 of a microtome according to the invention with magnets 34, ferromagnetic anchor plates 33 and positioning screws 48, for generating the brace force between the guidance body 15 and the spindle bearing 21, and with a changeover of the limit values of the brace force in the status of a first changeover position. The head of the positioning screw 48 is thereby in contact with the thinner zone of the respective segment of the segment ring 51, whereby the air gap between the magnet 34 and the ferromagnetic anchor plate 33 has a small value denoting this changeover position, and which represents an increased brace force.

FIG. 7j referring to the depiction in FIG. 7g, a rear view of a feed system 12 of a microtome according to the invention with changeover of the limit values of the brace force in the status of a second changeover position. The actuating means 50, consisting of the segment ring 51 and the pinion 52, are in engagement with each other. In reference to the depiction in FIG. 7h, the pinion 52 is rotated by 45° in clockwise direction. Therefore, with the depicted gearing the segment ring 51 is rotated as well by 45°, but in counter-clockwise direction. The positioning screws 48 protrude thru the slots at the segment ring 51 and brace themselves with their head now at the thicker zone of each of the helicoidal thickening segments.

FIG. 7k shows, referring to the depiction in FIG. 7g, a longitudinal section thru a feed system 12 of a microtome according to the invention with magnets 34, ferromagnetic anchor plates 33 and positioning screws 48, for generating the brace force between the guidance body 15 and the spindle bearing 21, and with a changeover of the limit values of the brace force in the status of a second changeover position. The head of the positioning screw 48 is thereby in contact with the thicker zone of the respective segment of the segment ring 51, whereby the air gap between the magnet 34 and the ferromagnetic anchor plate 33 has a higher value denoting this changeover position, and which represents a decreased brace force.

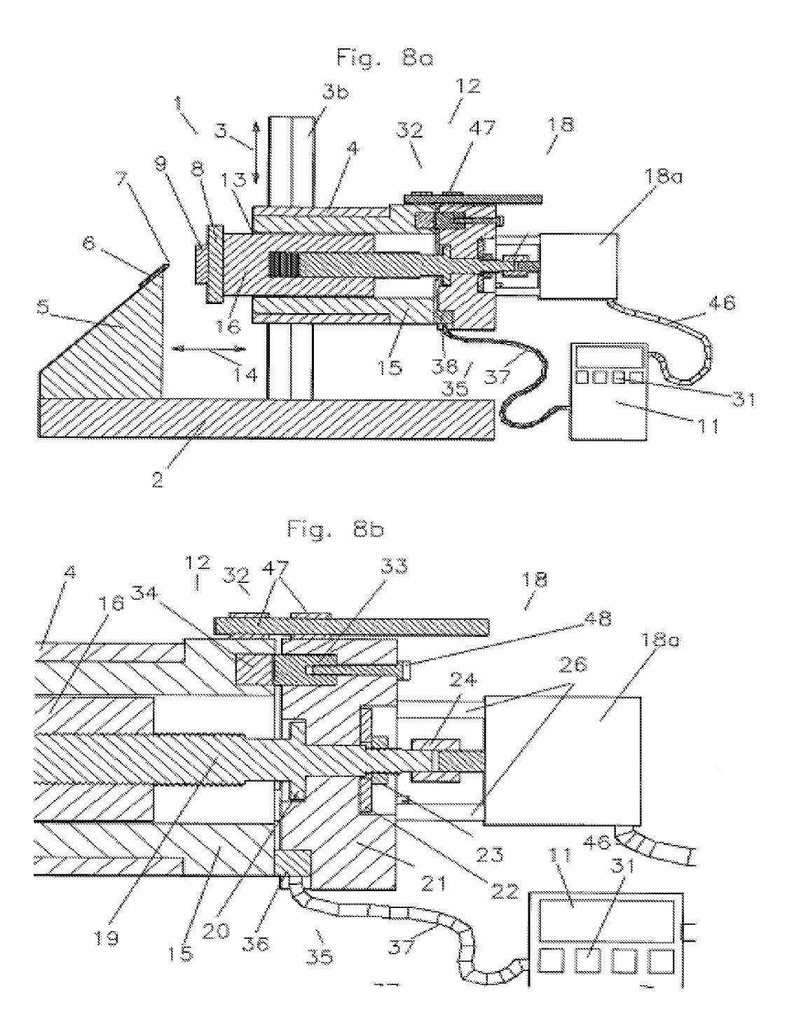

FIG. 8a shows a longitudinal section thru a microtome 1, in sectioning mode or in set-up mode, according to the invention with magnets 34 as part of the force generating means 32 for generating the brace force and with a piezo sensor 36 as detecting switching means 35. The main body 2 is firmly connected to the guidance of sectioning path 3b along which the support body 4 is moveable in direction of double arrow sectioning path 3. Likewise connected to the main body 2 is the knife carrier 5 which carries the sectioning tool 6 with the knife edge 7. The feed system 12, which is based on the embodiment illustrated in FIG. 7d, is firmly connected via the guidance body 15 to the support body 4. The specimen holder 8 with attached specimen 9 is connected to the guidance element 16, which can perform the feed movement along the linear guidance 13, indicated with double arrow 14. The interconnected feed means 18 are pressed with the brace force against the guidance body 15. The force generating means 32 determine by their characteristics and adjustments the value of the brace force. The guidance of the shifting range 47 is shown in this operating state as unmoved, because the interconnected feed means 18 are pressed against the guidance body 15 with the brace force of the force generating means 32. With activation of the electrical motor 18a by the electronic control 11 and the control panel 31 via the motor cable 46, the feed movement 14 will be carried out. FIG. 8b shows the embodiment in detail.

FIG. 8b shows a magnified detail thru a longitudinal section of a microtome 1, in sectioning mode or in set-up mode, according to the invention with magnets 34 as part of the force generating means 32 for generating the brace force and with a piezo sensor 36 as detecting switching means 35. The feed system 12, which is based on the embodiment illustrated in FIG. 7d, is firmly connected via the guidance body 15 to the support body 4. The interconnected feed means 18, consisting of the spindle 19, the spindle flange 20, the spindle bearing 21, the bearing disk 22, the spindle bearing nut 23, the shaft coupling 24, the mounting rods 26 and the electrical motor 18a are pressed via the piezo sensor 36, which is part of the detecting switching means 35, and which is fixed with one of its active surfaces to the spindle bearing 21, with its opposite active surface against the guidance body 15. The force generating means 32, consisting of the magnets 34, the ferromagnetic anchor plates 33 and the positioning screws 48, determine by their characteristics and adjustments the value of the brace force. The guidance of the shifting range 47 is shown in this operating state as unmoved, because the interconnected feed means 18 are pressed against the guidance body 15 with the brace force of the force generating means 32. With activation of the electrical motor 18a by the electronic control 11 and the control panel 31 via the motor cable 46, the feed movement 14 will be carried out by the spindle 19 acting on the nut thread at the guiding element 16. In case of a collision and following exceedance of the brace force, the interconnected feed means 18 are together shifted along the guidance of the shifting range 47. That commencing shift will, nevertheless there is given inherent safety at assumed undisturbed functionality, be detected, in this example, by the piezo sensor 36 and signaled to the electronic control 11 by the sensor cable 37, which also belongs to the detecting switching means 35. Subsequently the electronic control 11 is switching off the electric-motor 18a.

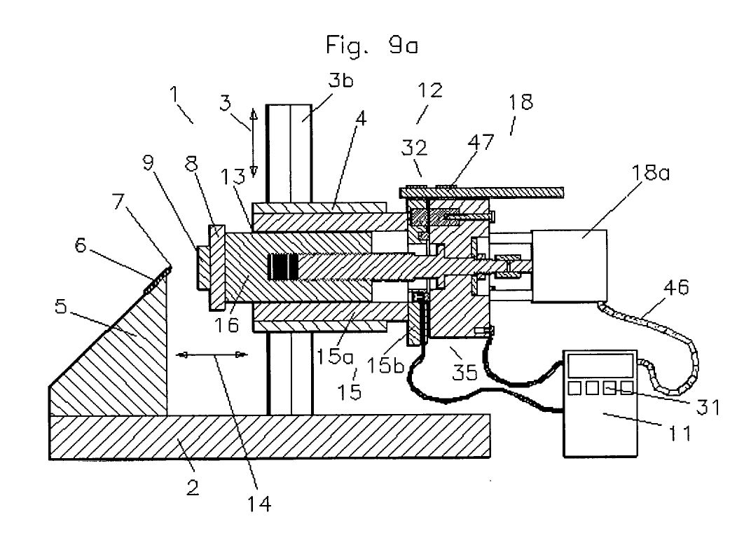

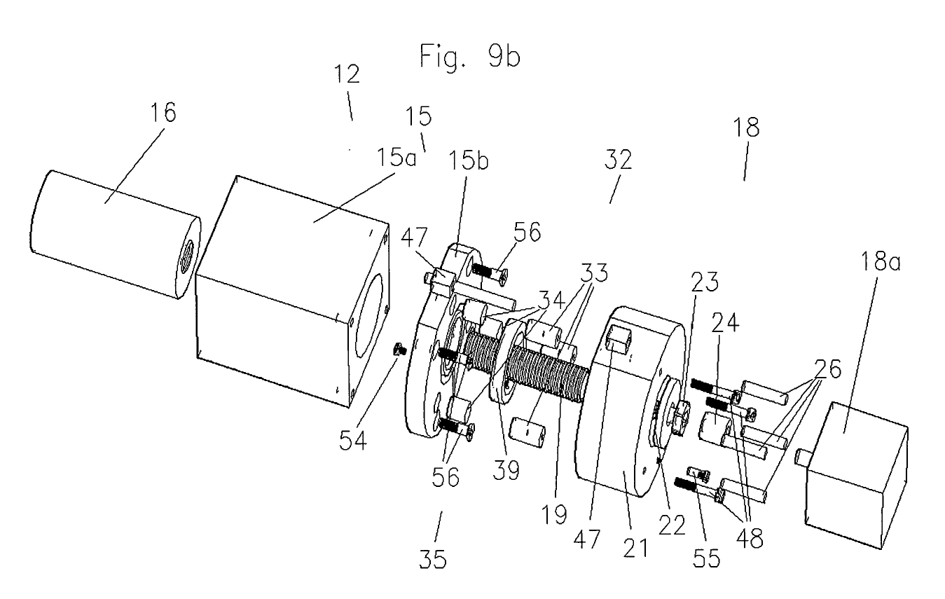

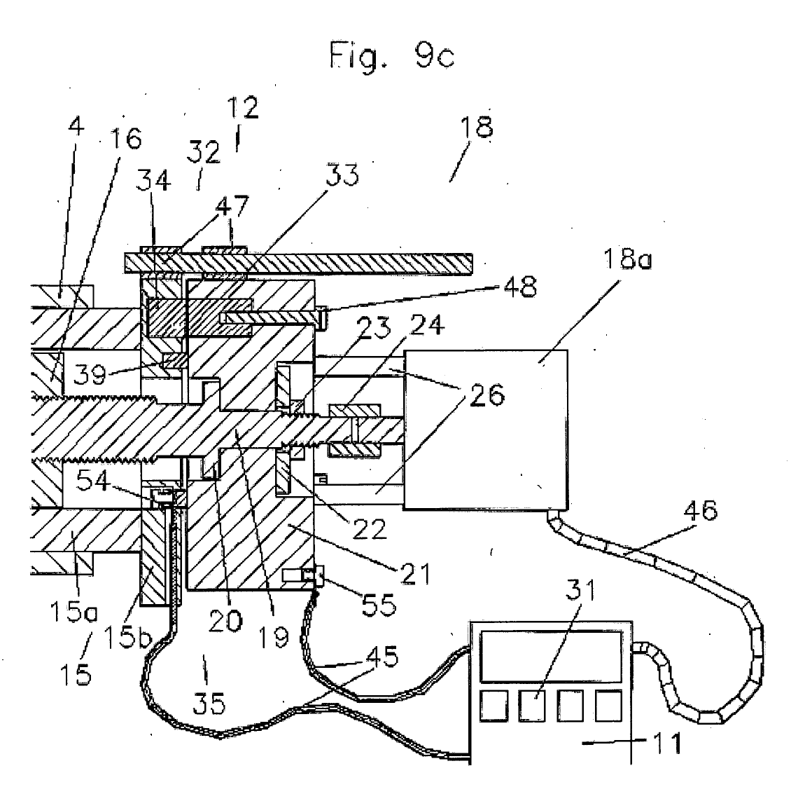

FIG. 9a shows a longitudinal section thru a microtome 1, in sectioning mode or in set-up mode, according to the invention with magnets 34 as part of the force generating means 32 for generating the brace force and with integrated detecting switching means 35. The main body 2 is firmly connected to the guidance of sectioning path 3b along which the support body 4 is moveable in direction of double arrow sectioning path 3. Likewise connected to the main body 2 is the knife carrier 5 which carries the sectioning tool 6 with the knife edge 7. The feed system 12, which is based on the embodiment illustrated in FIG. 7d, is firmly connected via the guidance body 15, which consists of the guidance body main part 15a and the guidance body isolated part 15b, to the support body 4. The specimen holder 8 with attached specimen 9 is connected to the guidance element 16, which can perform the feed movement along the linear guidance 13, indicated with double arrow 14. The interconnected feed means 18 are pressed with the brace force against the isolated part of the guidance body 15b. The force generating means 32 determine by their characteristics and adjustments the value of the brace force. The guidance of the shifting range 47 is shown in this operating state as unmoved, because the interconnected feed means 18 are pressed against the guidance body 15 with the brace force of the force generating means 32. With activation of the electrical motor 18a by the electronic control 11 and the control panel 31 via the motor cable 46, the feed movement 14 will be carried out. For a better understanding FIG. 9b shows an exploded view and FIG. 9c a magnified detail of this feed system 12.

FIG. 9b shows an exploded view of a feed system 12 of a microtome according to the invention with magnets 34, which are shown here as permanent magnets, as part of the force generating means 32 for generating the brace force and with integrated detecting switching means 35. The parts of the feed system 12 are: the guidance element 16, the guidance body 15, which consists of the guidance body main part 15a and the guidance body isolation part 15b, the guidance shifting range 47, the force generating means 32 and the interconnected feed means 18, which themselves, in this embodiment consist of: the electrical motor 18a, the spindle 19, the spindle bearing 21, the bearing disk 22, the spindle bearing nut 23, the shaft coupling 24 and the mounting rods 26. In this example, the force generating means 32 are the magnets 34 with the ferromagnetic anchor plates 33 and the positioning screws 48. The detecting switching means 35, in this example, consist of the contact ring 39, the contact screw F 54 and the contact screw Z 55, as well as the electrical connections between the contact screws to the electronic control, which are not shown in this depiction. In assembled condition the magnets 34 are connected at the guidance body 15, in this example at the guidance body isolation part 15b, for example by gluing together, and therefore they are stationary at a shift. The ferromagnetic anchor plates 33 are hold in position in the spindle bearing 21 by the positioning screws 48. Caused by the magnetic force which is acting between the magnets 34 and the ferromagnetic anchor plates 33, the spindle bearing 21 is pressed against the guidance body 15, in this example against the contact ring 39, which is inserted into the guidance body isolation part 15b, by a defined force. The guidance body isolation part 15b consists of an electrically non-conductive material of high rigidity, for example, a suitable plastic material in this regard or technical ceramics. The contact ring 39 consists of copper or brass or another suitable contact material. In order to effect the electrical connection to the electronic control, which is not shown here, serve the contact screw F 54 to connect with the contact ring 39 via a connection thread and the contact screw Z 55 to connect with the conductive spindle bearing 21, also via a connection thread there. The double function of the contact ring 39 and the spindle bearing 21 to serve on one hand as contact surface for the brace force and on the other hand as an electrical contact surface for detection of a commencing shift of the interconnected feed means 18, is illustrated in FIG. 9c.

FIG. 9c shows a magnified detail of a longitudinal section thru a feed system 12 of a microtome according to the invention with magnets 34 as part of the force generating means 32 for generating the brace force and with integrated detecting switching means 35. The feed system 12, which is based on the embodiment illustrated in FIG. 7d, is firmly connected via the guidance body isolated part 15b, to the support body 4.

Both parts, as well as the guidance element 16, are only partly visible in the magnified detail shown here. The interconnected feed means 18, consisting of the spindle 19, the spindle flange 20, the spindle bearing 21, the bearing disk 22, the spindle bearing nut 23, the shaft coupling 24, the mounting rods 26 and the electrical motor 18a are pressed with the brace force via the spindle bearing 21 against the contact ring 39, which is part of the detecting switching means 35, and which is inserted into the guidance body isolated part 15b. The force generating means 32, consisting of the magnets 34, the ferromagnetic anchor plates 33 and the positioning screws 48, determine by their characteristics and adjustments the value of the brace force. The guidance of the shifting range 47 is shown in this operating state as unmoved, because the interconnected feed means 18 are pressed against the guidance body 15 with the brace force of the force generating means 32. With activation of the electrical-motor 18a by the electronic control 11 and the control panel 31 via the motor cable 46, the feed movement will be carried out by the spindle 19 in conjunction with the nut thread at the guidance element 16. In case of a collision and following exceedance of the brace force, the interconnected feed means 18 are together shifted along the guidance of the shifting range 47. That commencing shift will, nevertheless there is given inherent safety at assumed undisturbed functionality, be immediately detected, in this example, by the integrated detecting switching means 35. In this example the detecting switching means consist of the contact ring 39, the therein screwed-in contact screw F 54, the contact screw Z 55, which is in contact with the spindle bearing 21, which is made from electrically conductive material, and the two electrical connections 45 which serve for connection between the contact screws 54 and 55 and the electronic control 11. With a commencing shift, caused by an exceedance of the brace force, the spindle bearing 21 is lifting its contact surface from the contact surface at the contact ring 39. Thus, for example, opens an existing electrical detection circuit, which is fed by the electronic control, and the contact ring 39 and the spindle bearing 21 adopt different electrical potentials, which will be interpreted as signal for the commencing shift. Following this signal, the electronic control is switching off the electric-motor 18a via the motor cable 46.

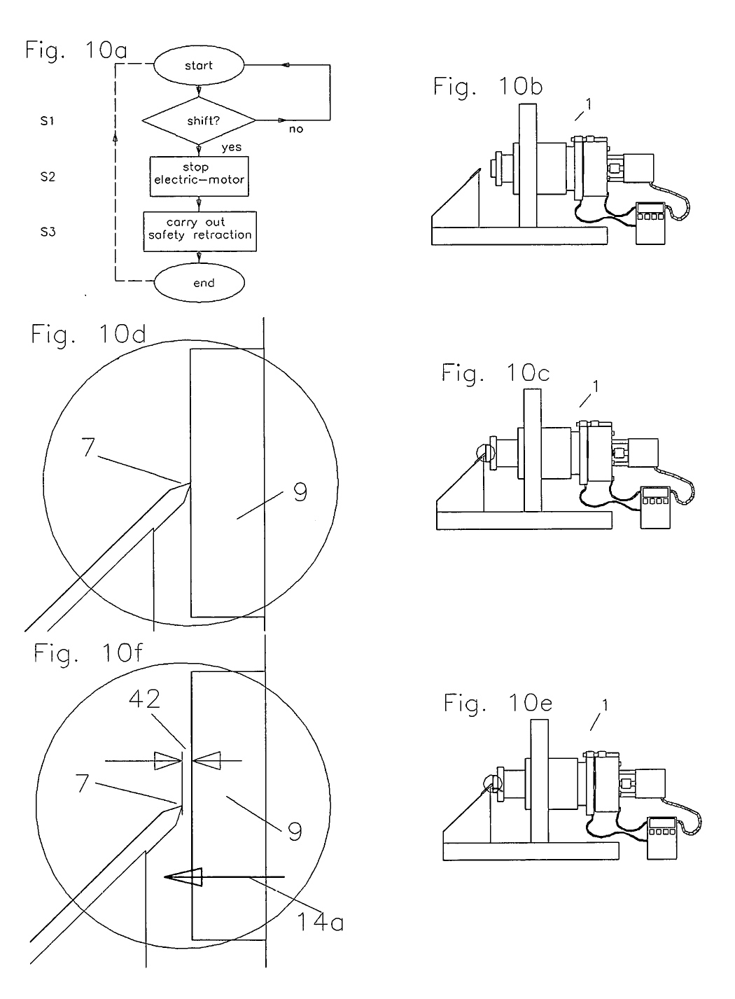

FIG. 10a shows a flow chart of a routine in the electronic control 11 of a microtome 1, according to the invention, for monitoring the switching-off function at a commencing shift 30 after a collision took place and for an afterwards rectification of the collision. The monitoring is permanent during the entire operation of the microtome 1. In step S1 of the flow chart it is questioned whether the detecting switching means 35 are signaling a shift 30 of the interconnected feed means 18 after an occurred collision. If a shift was reported, the driving electric-motor 18a of the feed system 12 will be switched off in step S2. In order to rectify a further continuing collision situation and to bring back the microtome 1 again in a usable state of operation step S3 takes place. In this step the electric-motor 18a will be actuated in counter direction to the feed direction 14a in order to drive with the feed system 12 the distance which represents the value of safety retraction 42. Herewith the specimen is located at a distance represented by the safety retraction 42 in front of the knife edge 7 and the microtome 1 is again ready for ordinary use.

FIG. 10b shows the microtome 1 according to the invention without automatic approach function in a certain distance between knife edge 7 and specimen 9.

FIG. 10c shows the microtome 1 according to the invention at an occurred collision in set-up mode, for example, caused by an operation error or by a first failure of a technical means. The depiction shows the situation after switching off the driving electric-motor 18a as result of a signal of the detecting switching means 35 and represents the situation after steps S1 and S2 in the flow chart of FIG. 10a.

FIG. 10d shows a magnified detail of the knife edge 7 and the specimen 9 at an occurred collision according to FIG. 10c. Obviously the knife edge 7 is in contact with the specimen 9.

FIG. 10e shows the microtome 1 according to the invention after a rectification of a collision, representing step S3 of the flow chart in FIG. 10a.

FIG. 10f shows a magnified detail of the knife edge 7 and the specimen 9 after a rectified collision and execution of the safety retraction 42 opposite to the feed direction 14a.

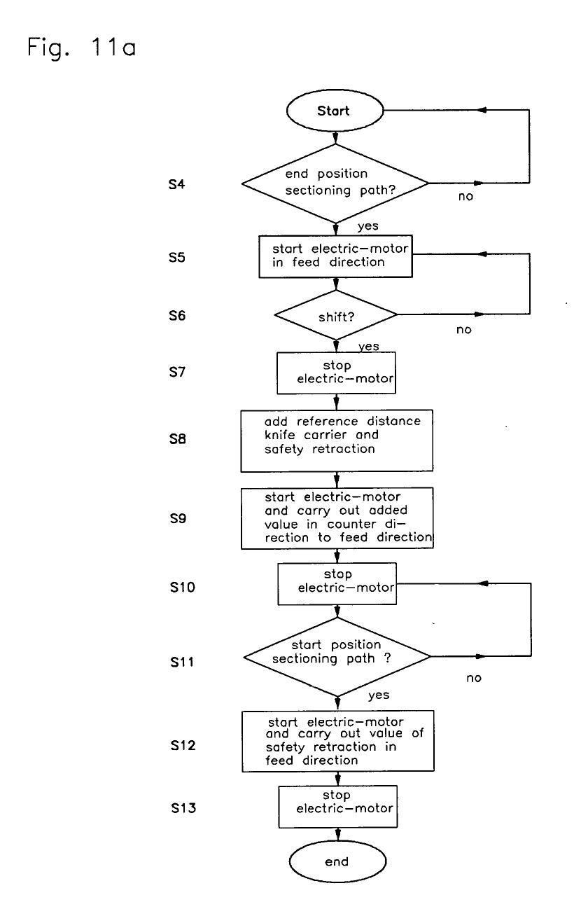

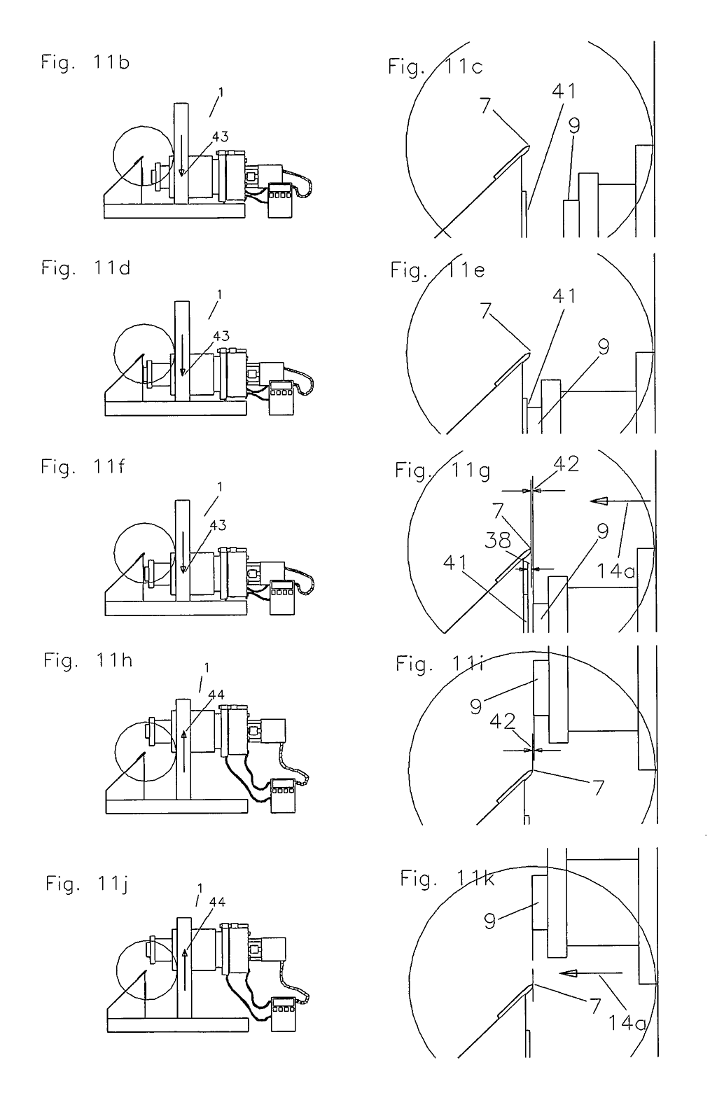

FIG. 11a shows a flow chart of a routine in the electronic control 11 of the microtome 1 according to the invention for execution of an automatic approach between the knife edge 7 and the specimen 9. After beginning of an automatic approach via the control panel 31 of the electronic control 11, it is questioned in step S4 of the flow chart, whether the specimen 9, or with embodiments with moveable knife carrier, the knife carrier 5, is positioned at end position sectioning path 43. This is the precondition, that the specimen 9 and the knife carrier reference surface 41 are located opposite to each other in a certain distance. Then, in step S5, the electric-motor 18a is actuated until the specimen 9 is colliding with the knife carrier reference surface 41 and the therefore commencing shift 30 being immediately signaled by the detecting switching means 35 to the electronic control 11. Consequently the electric-motor 18a will be switched off in step S7. In step S8 the electronic control determines the added value of the safety retraction 42 and the reference distance knife carrier 38, whereby the reference distance knife carrier 38 represents the gap by which the knife carrier reference surface 41 is backed away from the knife edge 7 in feed direction 14a. In step S9 now the electric motor 18a will be actuated and the added value will be carried out in counter direction to the feed direction 14a. Herewith the specimen 9 is located by the value of the safety retraction 42 in front of the knife edge 7. In step S10 the electric-motor 18a will be stopped after that execution took place. Now, the specimen 9, or with embodiments with moveable knife carrier, the knife carrier 5, must be moved to the start position sectioning path 44. For microtomes with a manual sectioning drive this has certainly to be performed by hand. For microtomes with a motorized sectioning drive, a respective sequence can be incorporated as branch operation to the flow chart for the electronic control. In step S11 of the actual flow chart is solely tested, that the microtome 1 should be now in its start position sectioning path 44. If true, the electric-motor 18a will be actuated again in step S12, in order to carry out the value of the safety retraction 42 in feed direction 14a. This means that the safety retraction 42 will be abrogated. After execution, the electric-motor 18a will be stopped again in step S13. Now the specimen 9 is in trim-position, that means it is located in feed direction 14a in the same position as the knife edge 7 and in sectioning direction above the knife edge 7. Herewith, the automatic approach function is completed.

FIG. 11b shows a microtome 1 according to the invention in end position sectioning path 43 previous to the beginning of an automatic approach between knife edge 7 and specimen 9.

FIG. 11c shows a magnified detail of the knife edge 7 and the specimen 9 previous to the beginning of an automatic approach according to FIG. 11b. Thereby the knife carrier reference surface 41 is located opposite to the specimen 9 in a certain distance. This is regardless of, whether it is, as in the depicted example, about a specimen feed system, or a knife carrier feed system and it is also regardless of whether, as in the depicted example, the specimen 9 is moved along the sectioning path 3 or the knife carrier 5 with the sectioning tool 6.

FIG. 11d shows a microtome 1 according to the invention in end position sectioning path 43 at an automatic approach between knife edge 7 and specimen 9 with collision with the knife carrier reference surface 41.

FIG. 11e shows a magnified detail of FIG. 11d with knife edge 7 and specimen 9 at an automatic approach in the state of collision with the knife carrier reference surface 41 and with, according to the invention, switched-off electric-motor 18a after the collision took place and the commencing shift 30 was immediately detected by the detecting switching means 35. In this state the specimen 9 is in contact with the knife carrier reference surface 41.

FIG. 11f shows a microtome 1 according to the invention in end position sectioning path 43 at an automatic approach between knife edge 7 and specimen 9 after rectification of a collision with the knife carrier reference surface 41 FIG. 11g shows a magnified detail of FIG. 11f with knife edge 7 and specimen 9 at an automatic approach after rectification of the collision with the knife carrier reference surface 41. Thereby illustrated is the reference distance knife carrier 38 between knife carrier reference surface 41 and knife edge 7, as well as the safety retraction 42, which represents a safety distance between the specimen 9 and the knife edge 7. At rectification of a previously existing collision, specimen 9, or with other embodiments, the knife edge 7, will be moved in opposite direction to the feed direction 14a by the sum of the reference distance knife carrier 38 and the safety retraction 42.

FIG. 11h shows a microtome 1 according to the invention, which is now representing the next step of the automatic approach sequence. The microtome 1 is depicted in start position sectioning path 44. The safety retraction 42 between the specimen 9 and the knife edge 7 still exists.

FIG. 11i shows a magnified detail of FIG. 11h with knife edge 7 and specimen 9 at an automatic approach procedure in a state with safety retraction 42.

FIG. 11j shows a microtome 1 according to the invention in start position sectioning path 44, after completion of an automatic approach procedure between the knife edge 7 and the specimen 9 and with abrogated safety retraction 42.

FIG. 11k shows a magnified detail of FIG. 11j with knife edge 7 and specimen 9 after completion of an automatic approach procedure between the knife edge 7 and the specimen 9, whereby, in this example, specimen 9 is positioned in start position sectioning path 44 and with regard to the feed direction 14a, in the same plane as the knife edge 7, and herewith in trim-position.

The microtome according to the invention and the herewith feasible methods according to the invention are considerably increasing the safety at the set-up mode of microtomes as well as in versions of cryostat-microtomes. The inherent safety in regard to inadmissible collision forces prevents damages to specimen and sectioning tools and reduces danger of injury at operation errors. The supplementary switching-off of the feed drive at a detected collision, nevertheless the given inherent safety, enables at a technically undisturbed operation an efficient work process and provides the basis for the thereof resting method of an automatic approach. The automatic approach function is to a large extent free from problems with debris in the area between knife carrier and specimen, as simply the recessed knife carrier reference surface needs to be free from soiling, and as there is no need for additional moveable or optical means. Moreover, in case of malfunction the automatic approach is certainly inherent safe as well.

### LIST OF COMPONENT PARTS

1 microtome

2 main body

3 double arrow sectioning path

3a disk bearing

3b guidance of sectioning path

3c rocking arm bearing

4 support body

5 knife carrier

6 sectioning tool

7 knife edge

8 specimen holder

9 specimen

10 sectioning drive

11 electronic control

12 feed system

13 linear guidance

14 double arrow feed movement

14a arrow feed direction

15 guidance body

15a main part guidance body

15b isolated part guidance body

16 guidance element

17 feed axis

18 interconnected feed means

18a electric motor

19 spindle

20 spindle flange

21 spindle bearing

22 bearing disk

23 spindle bearing nut

24 shaft coupling

25 fastening screw

26 mounting rod

27 spring sleeve

28 spring

29 spring rod

30 arrow shift

31 control panel

32 force generating means

33 ferromagnetic anchor plate

34 magnet

35 detecting switching means

36 piezo sensor

37 sensor cable

38 reference distance knife carrier

39 contact ring

41 knife carrier reference surface

42 safety retraction

43 end position sectioning path

44 start position sectioning path

45 electrical connection

46 motor cable

47 guidance shifting range

48 positioning screws

49 changeover means

50 actuating means

51 segment ring

52 pinion

53 actuator

54 contact screw F

55 contact screw Z

56 connection isolated part

a clearance angle

b wedge angle

c cutting angle

d shear angle

e friction angle

h feed thickness

i cutting thickness

Fₐ active force

F_{d} shear force

F_{dN} shear normal force

F_{R} cutting plane friction force

F_{N} normal force

F_{c} cutting force

Fₛ thrust

F_{K} collision force

F_{G} limit value of brace force

S1-S13 steps of flow charts

1. Microtome (1) with a main body (2) and a support body (4), which is moved along a sectioning path (3), a knife carrier (5) with a sectioning tool (6) and a knife edge (7), a specimen holder (8) and a specimen (9) to be thin-sectioned, a manual or motorized sectioning drive for operating a sectioning mode, an electronic control (11) and a feed system (12) for approach in set-up mode between specimen (9) to be thin-sectioned and knife edge 7 relative to each other, whereby the feed system (12) is comprised of a linear guidance (13) for a directed feed movement (14) between the specimen (9) and the knife edge (7) with a guidance body(15), which is firmly connected to either the main body (2) or to the support body (4), or which is made of one piece with the main body (2) or the support body (4), and with a guidance element (16) moveable in direction of the feed movement (14), interconnected feed means (18), which are connected between themselves and which contain an electric-motor (18a), which, when activated, effects a movement of the moveable guidance element (16) via the interconnected feed means (18) to which it is connected, while the interconnected feed means (18) are braced with at least one of their functional parts at the guidance body (15) of the feed system (12),
characterized in that the brace force in a feed direction (14a) is a limit value and that with an exceedance of that limit value in case of a collision between specimen (9) and knife edge (7), or a knife carrier reference surface (41), at a feed movement (14) in set-up mode, a shift (30) of the interconnected feed means (18) takes place in counter direction to the feed direction (14a), away from the guidance body 15 and along a guidance shifting range (47), whereby at least one part of force generating means (32) remain stationary with the guidance body (15), whereas at least one further part of the force generating means (32) is connected to one functional part of the interconnected feed means (18) and therefore does the same shift (30) as the interconnected feed means (18), and that the microtome (1) herewith is inherent safe in regard to occurring collision forces in set-up mode, as there is no increase of a collision force above the force which is determinant at the shift 30 and that the limit value of the brace force and the force determinant at a shift (30) are selected such that they are admitted operational parameters of the microtome (1).

2. Microtome (1) according to claim 1, characterized in that the limit value of the brace force is selected to be above the thrust (Fₛ) arising in sectioning mode in counter direction to the feed direction (14a) and below a force, which would in case of a collision lead to a damage at the specimen (9) or at the knife edge (7) and additionally the weight force of the interconnected feed means (18) in dependency of the installation position of the feed system (12) is considered.

3. Microtome (1) according to claim 1, characterized in that the limit value of the brace force is dependent on the operation mode of the microtome (1), whereby in sectioning mode the limit value of the brace force is selected to be above the thrust (Fₛ) arising in counter direction to the feed direction (14a) and below a force, which would in case of a collision lead to a damage at the specimen (9) or at the knife edge (7), whereby in set-up mode, in order to achieve an increased safety, a reduced limit value of the brace force below the thrust (Fₛ), which is acting only in sectioning mode, is applied, and whereby changeover means (49) exist, which can cause an increase and a decrease of the brace force, and whereby additionally the weight force of the interconnected feed means (18) in dependency of the installation position of the feed system (12) is considered.

4. Microtome (1) according to claim 1, characterized in that the brace force is generated by one or several springs (28), which act with their spring force between the interconnected feed means (18) and the guidance body (15).

5. Microtome (1) according to claim 1, characterized in that the brace force is generated by one or several magnets (34), which act with their magnetic force between the interconnected feed means (18) and the guidance body (15) and whereby the magnets (34) can be permanent magnets as well as electromagnets.

6. Microtome (1) according to claim 1, characterized in that in case of a collision the shift (30) of the interconnected feed means (18) takes effect on detecting switching means (35), which on their side, via the electronic control (11), cause to switch off the electric-motor (18a), at least in feed direction (14a), which is the collision precipitating direction.

7. Microtome (1) according to claim 6, characterized in that the guidance body (15) or a functional part of the interconnected feed means (18) has recesses into which one or several piezo sensors (36) are inserted as detecting switching means (35) for detecting a shift and whereby one of the active surfaces of the piezo sensors (36) directly serves as contact surface of the brace force between the guidance body (15) and the interconnected feed means (18).

8. Microtome (1) according to claim 6, characterized in that the guidance body (15) consists of an electrically non-conductive material, or is made of two parts, whereby at least one part consists of an electrically non-conductive material, and whereby the contact surface applied with the brace force consists of a therein inserted but protruding electrically conductive contact ring (39) or at least one electrically conductive pin, and whereby the conductive contact ring (39) or the conductive pin is electrically connected to the electronic control (11), and whereby the interconnected feed means (18) contain at least one electrically conductive part, which is as well electrically connected to the electronic control (11), providing that the contact surface between the contact ring (39), or the conductive pin, and the at least one electrically conductive part of the interconnected feed means (18) constitute an electrical contact, which opens at a commencing shift (30) and causes via the electronic control (11), to switch off the electric-motor (18a), at least in feed direction (14a), which is the direction precipitating the collision.

9. Microtome (1) according to claim 6, characterized in that one functional part of the interconnected feed means(18) consists of an electrically non-conductive material, or is made of two parts, whereby at least one part consists of an electrically non-conductive material, and whereby the contact surface applied with the brace force consists of a therein inserted but protruding electrically conductive contact ring (39) or at least one electrically conductive pin, and whereby the conductive contact ring (39) or the conductive pin is electrically connected to the electronic control (11), and whereby the guidance body (15) is electrically conductive and is as well electrically connected to the electronic control (11), providing that the contact surface between the contact ring (39), or the conductive pin, and the electrically conductive guidance body (15) constitute an electrical contact, which opens at a commencing shift (30) and causes via the electronic control (11), to switch off the electric-motor (18a), at least in feed direction (14a), which is the direction precipitating the collision.

10. Method for operating a microtome (1) according to claim 1 characterized in that an occurring collision between the specimen (9) and the knife edge (7), or another body surface of the knife carrier being situated on the feed path, and accordingly switched off electric-motor (18a) by the electronic control (11), caused by a shift (30) and thereof triggered detecting switching means (35), and that, depending on a respective pre-selection, the electronic control (11) thereafter activates on a manual or automatic command the electric-motor(18a) again in a way, that a distance is covered in counter direction to the feed direction (14a), which causes a rectification of the collision situation and therefore resets the triggered detecting switching means (35) in their initial state.

11. Method of operating a microtome (1) according to claim 1 characterized in that by a command via the control Panel (31) the electronic control (11) conducts the following sequence, which represents an automatic approach between specimen (9) and knife edge (7):
Verification: Support body (4) is in end position sectioning path (43), whereby specimen (9) is in a certain distance opposite to knife carrier reference surface (41)
Activation of electric-motor (18a) in feed direction (14a) until collision
Detection of collision between specimen (9) and knife carrier (5) at the knife carrier reference surface (41) at commencing shift (30) by evaluating the triggered detecting switching means (35) and switching-off of the electric motor (18a)
Activation of the electric-motor (18a) in counter direction to the feed direction (14a) for a distance which is equal to the sum of the distance in feed direction (14a) between the knife edge (7) and the knife carrier reference surface (41) plus the safety retraction (42)
Verification: the support body (4) is in start position sectioning path (44)
Activation of the electric-motor (18a) in feed direction (14a) for a distance which is equal to the absolute value of the safety retraction (42)
